(19) United States
(12) Patent Application Publication
(10) Pub. No.: US 2019/0122392 A1
(43) Pub. Date: Apr. 25, 2019

(54) IMAGE ANALYZING APPARATUS, IMAGE ANALYZING SYSTEM, AND METHOD OF OPERATING IMAGE ANALYZING APPARATUS

(71) Applicant: Olympus Corporation, Tokyo (JP)

(72) Inventors: Momoko Yamanashi, Tokyo (JP); Tetsuhiro Yamada, Tokyo (JP); Toshio Nakamura, Tokyo (JP); Ryuichi Toyama, Tokyo (JP); Takeo Suzuki, Tokyo (JP)

(73) Assignee: Olympus Corporation, Tokyo (JP)

(21) Appl. No.: 16/191,707

(22) Filed: Nov. 15, 2018

Related U.S. Application Data
(63) Continuation of application No. PCT/JP2017/014572, filed on Apr. 7, 2017.

(30) Foreign Application Priority Data
May 18, 2016 (JP) 2016-099750

(51) Int. Cl. G06T 7/90; G06T 5/50; G06T 7/00

(52) U.S. Cl. CPC G06T 7/90; G06T 5/50; G06T 2207/10068; G06T 2207/30004; G06T 7/0012

(57) ABSTRACT

An image analyzing apparatus includes an image input portion, an image processor, a distribution characteristic value calculator, a recording portion, and a comparison information output portion. The image input portion inputs an endoscopic image. The image processor generates a brightness-corrected image. The endoscopic image is corrected to the brightness-corrected image wherein the brightness-corrected image includes a brightness distribution that being substantially uniform. The distribution characteristic value calculator extracts at least one of a red color component, a green color component, and a blue color component in the brightness-corrected image and determines a first distribution characteristic value of the extracted color component. The recording portion records information including a plurality of second distribution characteristic values. The comparison information output portion compares the first distribution characteristic values and the second distribution characteristic value with each other.

### CROSS-REFERENCE TO RELATED APPLICATIONS

This application is a continuation application of PCT Application No. PCT/JP2017/014572 filed on Apr. 7, 2017, which in turn claim priority to the Japanese Patent Application No. 2016-99750 filed on May 18, 2016 in Japan which is hereby incorporated by reference in its entirety.

### TECHNICAL FIELD

The present disclosure relates to an image analyzing apparatus, an image analyzing system, and a method of operating an image analyzing apparatus, and more particularly to an image analyzing apparatus, an image analyzing system, and a method of operating an image analyzing apparatus for analyzing endoscopic images.

### DESCRIPTION OF THE RELATED ART

There have heretofore been practiced diagnoses using medical images acquired by medical imaging apparatus based on CT (Computer Tomography), MRI (Magnetic Resonance Imaging), and so on. Furthermore, JP 2013-200642A and JP 2016-6635A, for example, propose retrieval systems for retrieving medical images about cases in the past that are similar to captured medical images of a patient, so that the doctor can refer to the retrieved medical images in diagnosing the patient.

However, the proposed retrieval systems basically retrieve disease images of cases in the past that are similar to medical images obtained by CT or MRI, and do not take into consideration medical images having delicate changes in colors, such as images of mucous membranes. For example, endoscopic images, i.e., internal images of patients, are obtained by an observational optical system disposed in the distal-end portion of an endoscope. The endoscopic images tend to suffer luminance irregularities caused by (i) brightness deviations due to the light distribution characteristics of illumination light emitted from the distal-end portion of the endoscope, (ii) the inclination of the surface of the subject with respect to the optical axis of the observational optical system, (iii) the distance from the distal-end portion of the endoscope to the observation target, or (iv) unevenness of the surface of the subject.

Furthermore, it is not possible to retrieve with accuracy images of mucous membranes in various cases in the part, which are similar to medical images of mucous membranes that have delicate changes in colors.

It is therefore an object of the present disclosure to provide an image analyzing apparatus, an image analyzing system, and a method of operating an image analyzing apparatus for retrieving with accuracy endoscopic images which are similar to obtained medical images containing color information while restraining the effects of luminance irregularities in the endoscopic images.

### BRIEF SUMMARY OF EMBODIMENTS

An image analyzing apparatus according to an aspect of the present disclosure includes an image input portion, an image processor, a distribution characteristic value calculator, a recording portion, and a comparison information output portion. The image input portion is configured to input an endoscopic image of a body which is acquired by an endoscope inserted into the body. The image processor is configured to generate a brightness-corrected image. The brightness-corrected image is constructed from the endoscopic image that being corrected to the brightness-corrected image. The brightness-corrected image includes a brightness distribution that being substantially uniform. The distribution characteristic value calculator is configured to extract at least one of a red color component, a green color component, and a blue color component in the brightness-corrected image. The distribution characteristic value calculator is configured to determine a first distribution characteristic value based on luminance values of the color component extracted from the brightness-corrected image and numbers of pixels corresponding to the luminance values. The recording portion is configured to record information including a plurality of second distribution characteristic values based on luminance values with respect to the color components of a plurality of endoscopic images and numbers of pixels corresponding to the luminance values. The comparison information output portion is configured to compare the plurality of second distribution characteristic values and the first distribution characteristic value with each other. The comparison information output portion is configured to output information regarding a state of the examinee from the result of comparison.

An image analyzing system according to another aspect of the present disclosure includes an endoscope and an image analyzing apparatus according to the present disclosure.

A method of image analyzing according to a further aspect of the present disclosure includes inputting an endoscopic image of a body which is acquired by an endoscope inserted into the body. The method includes generating a brightness-corrected image constructed from the endoscopic image that being corrected to the brightness-corrected image. The brightness-corrected image includes a brightness distribution that being substantially uniform. The method includes extracting at least one of a red color component, a green color component, and a blue color component in the processed image. The method includes determining, with a distribution characteristic value calculator, a first distribution characteristic value based on luminance values of the color component extracted from the brightness-corrected image and numbers of pixels corresponding to the luminance values. The method includes obtaining a plurality of second distribution characteristic values with respect to the color components of the endoscopic image. The plurality of second distribution characteristic values and numbers of pixels corresponding to the luminance values are recorded in a recording portion. The method includes comparing the plurality of second distribution characteristic values with the first distribution characteristic value. The method includes outputting information regarding a state of the body from the result of comparison.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram illustrating the general configuration of an image analyzing system according to an embodiment of the present disclosure.

FIG. 2 is a block diagram illustrating the configuration of a signal generator 33 according to the embodiment of the present disclosure.

FIG. 3 is a block diagram illustrating the configuration of an image processor 34 according to the embodiment of the present disclosure.

FIG. 4 is a block diagram illustrating the configuration of a distribution characteristic value calculator 35 according to the embodiment of the present disclosure.

FIG. 5 is a block diagram illustrating the configuration of a comparison information output portion 36 according to the embodiment of the present disclosure.

FIG. 6 is a block diagram illustrating the configuration of a structured element designator 52 of the signal generator 33 according to the embodiment of the present disclosure.

FIG. 7 is a diagram illustrating a process from the retrieval of disease information similar to a captured endoscopic image to the outputting of the retrieved disease information according of the embodiment of the present disclosure.

FIG. 8 is a flowchart of a process from the acquisition of an endoscopic image to the presentation of disease information according of the embodiment of the present disclosure.

FIG. 9 is a flowchart of the process from the acquisition of an endoscopic image to the presentation of disease information according of the embodiment of the present disclosure.

FIG. 10 is a view illustrating an analysis target area AA in an endoscopic image according of the embodiment of the present disclosure.

FIG. 11 is a flowchart illustrating an example of the flow of a process for designating a structured element according of the embodiment of the present disclosure.

FIG. 12 is a flowchart illustrating the example of the flow of the process for designating a structured element according of the embodiment of the present disclosure.

FIG. 13 is a view illustrating at an enlarged scale an endoscopic image of a body and an element of interest according of the embodiment of the present disclosure.

FIG. 14 is a view illustrating the structure of a cilium in the intestinal tract as an element of interest according of the embodiment of the present disclosure.

FIG. 15 is a view illustrating an example of an endoscopic image according of the embodiment of the present disclosure.

FIG. 16 is a graph illustrating a luminance value distribution of a pixel group on a line L indicated by the two-dot-and-dash line in an analysis target area AA in the endoscopic image illustrated in FIG. 15.

FIG. 17 is a diagram illustrating a structured element according of the embodiment of the present disclosure.

FIG. 18 is a flowchart illustrating an example of the flow of a process for generating a corrective image CP according of the embodiment of the present disclosure.

FIG. 19 is a graph illustrating a luminance value distribution of a pixel group in the generated corrective image CP according of the embodiment of the present disclosure.

FIG. 20 is a graph illustrating a luminance value distribution of a pixel group in a generated post-correction image AP according of the embodiment of the present disclosure.

FIG. 21 is a histogram of luminance values in the post-correction image AP according of the embodiment of the present disclosure.

FIG. 22 is a diagram illustrating a displayed example of disease candidate information displayed on a display device 5 according of the embodiment of the present disclosure.

FIG. 23 is a histogram representing luminance values produced by standardizing sums of luminance values of three color components RGB in an endoscopic image of a normal gastric mucous membrane and the numbers of pixels corresponding to the luminance values according of the embodiment of the present disclosure.

FIG. 24 is a histogram representing luminance values of a color component R in the endoscopic image of the normal gastric mucous membrane and the numbers of pixels corresponding to the luminance values according of the embodiment of the present disclosure.

FIG. 25 is a histogram representing luminance values of a color component G in the endoscopic image of the normal gastric mucous membrane and the numbers of pixels corresponding to the luminance values according of the embodiment of the present disclosure.

FIG. 26 is a histogram representing luminance values produced by standardizing sums of luminance values of three color components RGB in an endoscopic image of a gastric mucous membrane suffering a disease A and the numbers of pixels corresponding to the luminance values according of the embodiment of the present disclosure.

FIG. 27 is a histogram representing luminance values of a color component R in an endoscopic image of a gastric mucous membrane suffering the disease A and the numbers of pixels corresponding to the luminance values according of the embodiment of the present disclosure.

FIG. 28 is a histogram representing luminance values of a color component G in the endoscopic image of the gastric mucous membrane suffering the disease A and the numbers of pixels corresponding to the luminance values according of the embodiment of the present disclosure.

FIG. 29 is a diagram illustrating an example of an endoscopic image where the standard deviation of a luminance value distribution is small according of the embodiment of the present disclosure.

FIG. 30 is a diagram illustrating an example of an endoscopic image where the standard deviation of a luminance value distribution is large according of the embodiment of the present disclosure.

FIG. 31 is a graph illustrating the differences between standard deviations with respect to respective diseases according of the embodiment of the present disclosure.

FIG. 32 is a block diagram illustrating the configuration of a recording portion according to Modification 1 of the embodiment of the present disclosure.

FIG. 33 is a graph illustrating an example of waveform data of a luminance value distribution of a certain color according to Modification 2 of the embodiment of the present disclosure.

FIG. 34 is a graph illustrating an example of waveform data of a luminance value distribution of a certain color according to Modification 2 of the embodiment of the present disclosure.

FIG. 35 is a part of a flowchart of a process from the acquisition of an endoscopic image to the presentation of disease information according of Modification 3 of the embodiment of the present disclosure.

FIG. 36 is a block diagram of a signal generator 33A according to Modification 5 of the embodiment of the present disclosure.

FIG. 37 is a diagram illustrating a process for generating a pre-correction image BPP free of luminance irregularities according to Modification 5 of the embodiment of the present disclosure.

FIG. 38 is a block diagram of a signal generator 33B according to Modification 6 of the embodiment of the present disclosure.

FIG. 39 is a diagram illustrating three points designated in a pre-correction image BP according to Modification 6 of the embodiment of the present disclosure.

FIG. 40 is a diagram illustrating an example wherein an image in an analysis target area AA of a live image display portion G1 is displayed in a color map according to Modification 7 of the embodiment of the present disclosure.

### DETAILED DESCRIPTION OF THE EMBODIMENTS

In the following description, various embodiments of the technology will be described. For purposes of explanation, specific configurations and details are set forth in order to provide a thorough understanding of the embodiments. However, it will also be apparent to one skilled in the art that the technology disclosed herein may be practiced without the specific details. Furthermore, well-known features may be omitted or simplified in order not to obscure the embodiment being described.

Identical parts are denoted by identical numeral references in the description given hereinafter. The figures are schematic and it is to be noted that the relationship between thicknesses and widths of various parts, the ratios of various parts, and so on illustrated in the figures are different from those in reality. Parts illustrated in some figures have different dimensions and ratios between those figures.

System Configuration

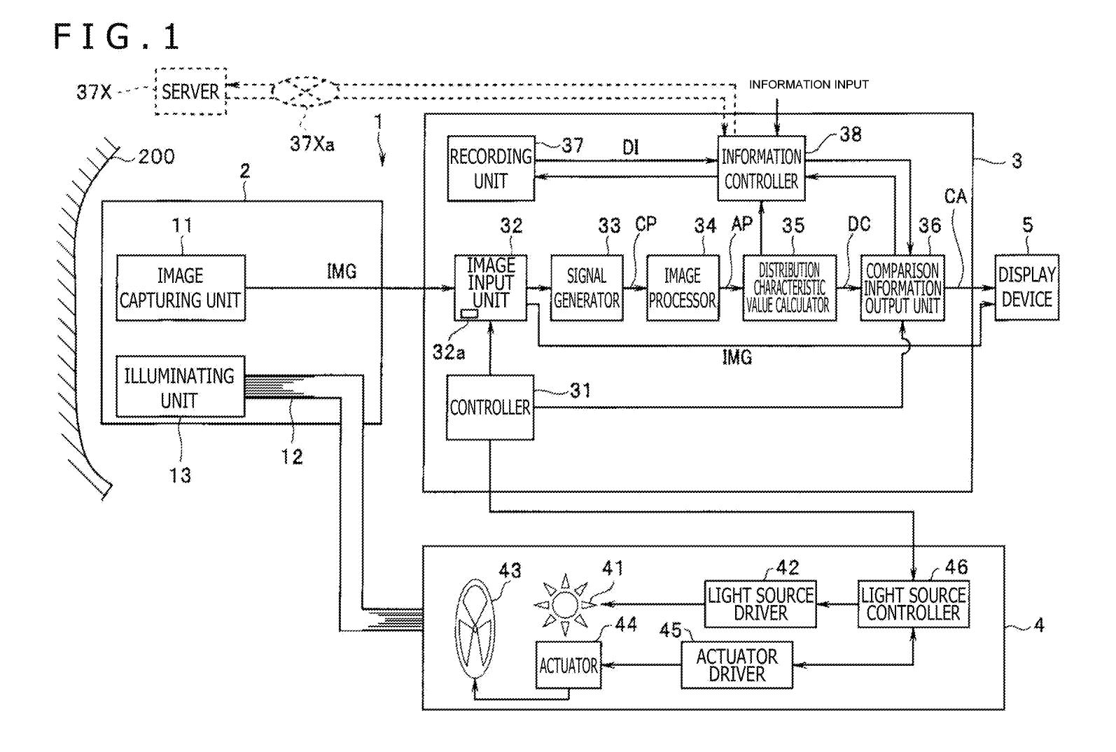

FIG. 1 is a block diagram illustrating the general configuration of an image analyzing system according to an embodiment of the present disclosure.

In the embodiment hereinafter, an endoscopic system will be illustrated as an “image analyzing system,” and a video processor as “image analyzing apparatus.”

As illustrated in FIG. 1, an endoscopic system 1 as an image analyzing system mainly includes an endoscope 2, a video processor 3 as an image analyzing apparatus, a light source device 4, and a display device 5.

According to the present embodiment, the endoscopic system 1 is not only capable of normal-light observation using white light, but also is able to cope with narrow-band light observation (NBI: Narrow Band Imaging, hereinafter referred to as “NBI”), in its entirety.

The endoscope 2 includes a slender insertion portion, an image capturing portion 11, a light guide 12, and an illuminating portion 13. The slender insertion portion is not depicted and is inserted into a body 200. The image capturing portion 11 is disposed in the distal-end portion of the insertion portion configured to capture an image of the body 200 to acquire an image signal. The light guide 12 transmits illumination light from the light source device 4. The illuminating portion 13 applies illumination light to the body 200. A body image acquiring portion is configured to acquire an image of the body. An illuminating window illuminates the body. The body image acquiring portion and the illuminating window are disposed on one surface of the distal end of the distal-end portion of the insertion portion of the endoscope 2.

Although the illumination is performed using the light guide herein, a light-emitting device such as a plurality of light-emitting diodes (hereinafter referred to as “LEDs”) may be mounted on the distal-end portion of the insertion portion and illumination light from the LEDs may be emitted.

A distal-end hood, a distal-end attachment or the like, for example, can be mounted on the distal end of the endoscope 2 for performing magnified NBI observation with reduced noise components.

The endoscope 2 includes a manipulator, not depicted, and the user of the endoscopic system 1, who is the user, can operate manipulating members including a freeze button, a release button, a bending button, etc. on the manipulator to acquire images of small intestinal villi and gastric mucous membranes, for example, of the body 200, to bend a bendable portion in the distal-end portion of the insertion portion, and to perform other operations.

The light source device 4 is connected to the endoscope 2 and the video processor 3. The light source device 4 includes a light source 41, a light source driver 42, a rotary filter 43, an actuator 44, an actuator driver 45, and a light source controller 46.

The light source 41 includes a white LED, a xenon lamp, or the like, and produce white light under the control of the light source controller 46. The light source driver 42 causes the light source 41 to produce white light under the control of the light source controller 46. The light emitted from the light source 41 is transmitted through the rotary filter 43, a condensing lens, not depicted, and the light guide 12 and emitted from the illuminating portion 13 of the endoscope 2.

When in a narrow-band light observation (hereinafter referred to as “NBI”) mode, the rotary filter 43 is disposed on the light path of white light produced by the light source 41, and receives the white light from the light source 41 and transmits therethrough light for NBI, i.e., narrow-band light including wavelength ranges of blue light in the vicinity of a wavelength of 415 nm, e.g., in a wavelength range of 400 to 440 nm, and green light in the vicinity of a wavelength of 540 nm, e.g., in a wavelength range of 525 to 555 nm. A filter for normal-light observation is omitted from illustration in FIG. 1.

In the NBI mode, therefore, the illuminating portion 13 illuminates the body with narrow-band light in a narrower band than white light. An image obtained by the endoscope 2 is an image of reflected light produced when the body is illuminated with illumination light in a predetermined wavelength band narrower than white light.

According to the NBI employed in the present embodiment, usually, narrow-band light includes blue light and green light. The narrow-band light is applied to an intestinal mucous membrane surface. An endoscopic image of (i) blue light and green light that are converted from reflected blue light and (ii) red light that is converted from reflected green light is displayed on the display device 5.

According to the present embodiment, two narrow-band lights including blue light in the vicinity of the wavelength of 415 nm and green light in the vicinity of the wavelength of 540 nm are used for NBI. However, either one of the two narrow-band lights including blue light in the vicinity of the wavelength of 415 nm and green light in the vicinity of the wavelength of 540 nm may be used, and narrow-band light in one or two or more wavelength bands may be sued.

When the endoscopic system 1 is set to a normal-light observation mode, the light source device 4 emits white light as illumination light. When the endoscopic system 1 is set to the NBI mode, the light source device 4 emits narrow-band light as illumination light.

The actuator driver 45 supplies a predetermined current to the actuator 44 under the control of the light source controller 46. The actuator 44 rotates the rotary filter 43 based on a synchronizing signal sent from the video processor 3 under the control of the light source controller 46.

The display device 5 is connected to the video processor 3, and has a function to receive, from the video processor 3, a body image, etc. generated by the video processor 3 via a predetermined video cable and display the received body image, etc.

Configuration of the Video Processor

The endoscope 2 and the light source device 4 are connected to the video processor 3. The video processor 3 includes a controller 31, an image input portion 32, a signal generator 33, an image processor 34, a distribution characteristic value calculator 35, a comparison information output portion 36, and a recording portion 37. The controller 31 integrally controls the endoscopic system 1 in its entirety. The image input portion 32 is controlled by the controller 31. The comparison information output portion 36 includes an image analyzer.

According to the present embodiment, the video processor 3 performs a function as a signal processing device for processing a captured image signal from the image capturing portion 11 of the endoscope 2, and is also used as an “image analyzing apparatus.”

The video processor 3 has a central processing unit (hereinafter referred to as “CPU”), a ROM (Read Only Memory), a RAM (Random Access Memory), a hard disc drive, and so on. The controller 31 controls the endoscopic system 1 in its entirety and realizes the functions when the CPU reads and executes programs stored in the ROM, etc.

The video processor 3 has an input device, not depicted, such as a control panel or the like, through which the user can set an observation mode, enter parameters, and set or enter various items of information such as patient information, etc. into the video processor 3. The entered items of information are stored in the recording portion 37. An information controller 38 can output information such as patient information, etc. to the comparison information output portion 36.

When disease candidates are to be retrieved, information entered from outside by the user, i.e., basic patient information, and information automatically acquired from the distribution characteristic value calculator 35, i.e., distribution characteristic values, an image capturing mode, and various items of patient information, are sent from the comparison information output portion 36 and saved in the recording portion 37 via the information controller 38. When disease candidates are not to be retrieved, information is sent from the distribution characteristic value calculator 35 to the information controller 38.

The recording portion 37 has a function as a memory. The information controller 38 performs various operations on information with respect to the recording portion 37, e.g., calls information recorded in the recording portion 37 and saves information in the recording portion 37 in association with other information such as images or the like.

The video processor 3 controls operation of the image input portion 32, the signal generator 33, the image processor 34, the distribution characteristic value calculator 35, the comparison information output portion 36, and the recording portion 37 when the CPU reads and executes programs stored in the ROM, etc.

The image input portion 32 receives a captured image signal representing an endoscopic image IMG from the image capturing portion 11 of the endoscope 2. The image input portion 32 generates frame-by-frame image data from the received captured image signal. Specifically, the image input portion 32 is supplied with an endoscopic image IMG of the body acquired by the image capturing portion 11. The image input portion 32 generates image data frame by frame. As described hereinafter, the image input portion 32 has a memory 32a such as a RAM or the like for storing image data in a predetermined number of frames based on a captured image signal from the endoscope 2.

The image input portion has a function to (i) sort out the image data according to a time sequence and (ii) output frames of image data that are designated by a control signal from the controller 31 to the signal generator 33.

The signal generator 33 generates image data of a corrective image CP from the image data of the endoscopic image IMG from the image input portion 32.

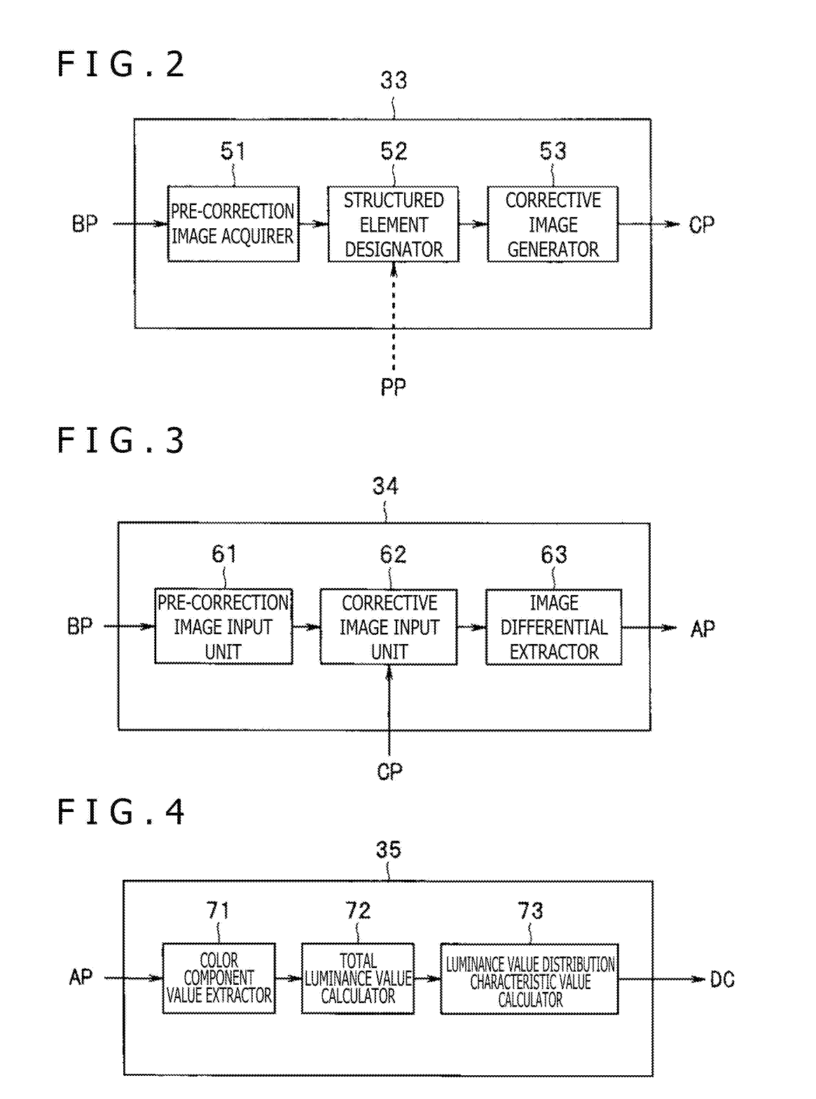

FIG. 2 is a block diagram illustrating the configuration of the signal generator 33. The signal generator 33 includes a pre-correction image acquirer 51, a structured element designator 52, and a corrective image generator 53.

The pre-correction image acquirer 51 is a processor for acquiring image data of an analysis target area AA in the endoscopic image IMG from the image input portion 32.

Regarding the endoscopic image IMG the pre-correction image acquirer 51 is supplied with a pre-correction image BP that is an image before a brightness distribution due to the light distribution characteristics of illumination light is corrected.

The structured element designator 52 is a processor for designating a structured element parameter matching an analysis target. The structured element designator 52 calculates a structured element parameter matching an analysis target from the image data of the pre-correction image BP representing the analysis target regarding the endoscopic image IMG. The structured element parameter is calculated such that it will have a value depending on the size of the analysis target. The configuration of the structured element designator 52 and a process for calculating a structured element parameter will be described hereinafter.

The corrective image generator 53 is a processor for generating and outputting a corrective image CP to be used for correcting image data, according to an image processing sequence to be described hereinafter. A process for generating a corrective image CP will be described hereinafter.

Referring back to FIG. 1, the image processor 34 is a processor for being supplied with the image data of the pre-correction image BP and the corrective image CP with respect to the endoscopic image IMG and performing an image processing sequence for generating corrected image data, i.e., a post-correction image AP.

FIG. 3 is a block diagram illustrating the configuration of the image processor 34. The image processor 34 includes a pre-correction image input portion 61, a corrective image input portion 62, and an image differential extractor 63.

The pre-correction image input portion 61 is a processor for being supplied with the pre-correction image BP as an analysis target. The pre-correction image BP of the endoscopic image IMG is output from the image input portion 32.

The corrective image input portion 62 is a processor for acquiring the corrective image CP generated by the corrective image generator 53. The corrective image CP of the endoscopic image IMG is output from the signal generator 33.

The image differential extractor 63 is supplied with the pre-correction image BP and the corrective image CP with respect to the endoscopic image IMG The image differential extractor 63 identifies the difference between the pre-correction image BP and the corrective image CP to extract a differential image, and outputs the differential image as a post-correction image AP. The image differential extractor 63 thus generates a post-correction image AP of the analysis target area AA in the endoscopic image IMG and outputs the generated post-correction image AP to the distribution characteristic value calculator 35. The post-correction image AP is a brightness-corrected image constructed from endoscopic image. The endoscopic image is corrected to the brightness-corrected image wherein the brightness-corrected image includes a brightness distribution that is substantially uniform.

In other words, the image processor 34 constitutes an image generator configured to generate a brightness-corrected image constructed from the endoscopic image of the body that is corrected such that the brightness distribution of the brightness-corrected image of the body is substantially uniform.

A process for generating a post-correction image AP in the image processor 34 will be described hereinafter.

Referring back to FIG. 1, the distribution characteristic value calculator 35 is a processor for being supplied with the post-correction image AP with respect to the endoscopic image IMG and calculating distribution characteristic values.

FIG. 4 is a block diagram illustrating the configuration of the distribution characteristic value calculator 35. The distribution characteristic value calculator 35 includes a color component value extractor 71, a total luminance value calculator 72, and a luminance value distribution characteristic value calculator 73.

The color component value extractor 71 extracts color component values, i.e., a red color component value (hereinafter also referred to as “R component value”), a green color component value (hereinafter also referred to as “G component value”), and a blue color component value (hereinafter also referred to as “B component value”), in the post-correction image AP of the endoscopic image IMG output from the image differential extractor 63.

The total luminance value calculator 72 calculates a luminance value, or a total luminance value, about the sum of the color component values in the post-correction image AP of the endoscopic image IMG which have been extracted by the color component value extractor 71.

The luminance value distribution characteristic value calculator 73 calculates distribution characteristic values about the color component values, i.e., the R component value, the G component value, and the B component value, in the post-correction image AP, and a distribution characteristic value regarding the total luminance value calculated by the total luminance value calculator 72, as distribution characteristic value information

DC. According to the present embodiment, a “distribution characteristic value” is determined as a standard deviation of a pixel value distribution of a plurality of pixels, i.e., a luminance value distribution, in the analysis target area AA.

Therefore, the distribution characteristic value calculator 35 (i) extracts color component values of the post-correction image AP of the endoscopic image IMG generated by the image differential extractor 63, and (ii) calculates the distribution characteristic value of the luminance value about the sum of the extracted color component values and the distribution characteristic values of the luminance values about the color component values as the distribution characteristic value information DC, as described in detail hereinafter.

Specifically, the distribution characteristic value calculator 35 extracts at least one of a red color component, a green color component, and a blue color component in the post-correction image AP which is a brightness-corrected image, and determines a distribution characteristic value of the extracted color component. When the body is illustrated with narrow-band light in the NBI mode, the distribution characteristic value calculator 35 extracts at least a green color component and a blue color component in the post-correction image AP which is a brightness-corrected image, and determines distribution characteristic values of the extracted color components.

The comparison information output portion 36 retrieves disease information having distribution characteristic values that coincide with or are similar to the distribution characteristic values obtained by the distribution characteristic value calculator 35, and outputs the retrieved disease information as disease candidate information CA.

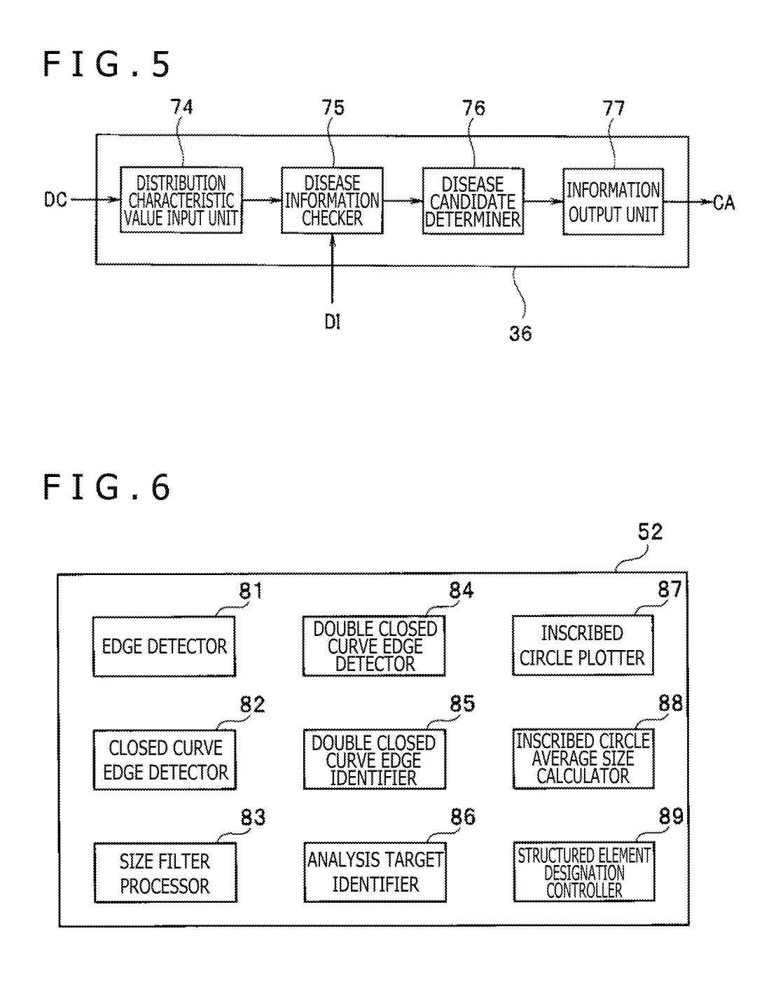

FIG. 5 is a block diagram illustrating the configuration of the comparison information output portion 36. The comparison information output portion 36 includes a distribution characteristic value input portion 74, a disease information checker 75, a disease candidate determiner 76, and an information output portion 77.

The distribution characteristic value input portion 74 is a processor for being supplied with the distribution characteristic value information DC from the luminance value distribution characteristic value calculator 73.

The disease information checker 75 is a processor for comparing the distribution characteristic value information DC with distribution characteristic values of respective diseases included in disease information DI recorded in the recording portion 37, and calculates degrees of coincidence therebetween.

A standard deviation of the luminance value distribution of the pixels in the analysis target area AA is used as a distribution characteristic value. Two standard deviation are compared with each other. A first standard deviation is included in the distribution characteristic value information DC. A second standard deviation in the disease information DI is recorded in the recording portion 37 to be described hereinafter.

Moreover, the disease information checker 75 calculates a degree of coincidence from the comparison result according to predetermined processing operations, with respect to each of the diseases included in the disease information DI recorded in the recording portion 37. The degree of coincidence refers to a ratio at which a standard deviation included in the distribution characteristic value information DC and a standard deviation in the disease information DI are similar to each other or coincide with each other.

The disease candidate determiner 76 determines a disease having a high degree of coincidence based on information of the degree of information from the disease information checker 75, as a disease candidate from the disease information DI recorded in the recording portion 37.

The information output portion 77 generates disease candidate information CA identified by the disease candidate determiner 76 and outputs the generated disease candidate information CA to the display device 5.

The display device 5 is also supplied with the endoscopic image IMG from the image input portion 32, and is capable of displaying live images and still images.

Referring back to FIG. 1, the recording portion 37 is a mass memory such as a hard disk drive where the disease information DI is recorded as template information.

The template information includes image data of endoscopic images of a plurality of cases and distribution characteristic value data associated with the respective image data with respect to each of the regions of the body. In other words, the recording portion 37 includes information regarding a plurality of diseases.

The recording portion 37 includes as the template information therein a plurality of distribution characteristic value data of a plurality of disease images, information of luminance value distributions of red color components, green color components, and blue color components in the disease images, and information of the disease images.

For example, if a region to be examined is a stomach, then each case represents atrophic gastritis or metastatic gastric cancer. The recording portion 37 records as the disease information DI therein with respect to each gastric case image data of endoscopic images of a plurality of typical cases in association with distribution characteristic value data, or standard deviation data herein, about those image data. The disease information DI is registered in advance in the recording portion 37.

Moreover, the disease information DI is registered in the recording portion 37 for each observation mode. Herein, the disease information DI in each of the NBI mode and the normal light observation mode using white light is recorded. The estimation of a disease to be described hereinafter is applicable to not only endoscopic images obtained in the NBI mode but also endoscopic images obtained in the normal light observation mode using white light.

Distribution characteristic values of the endoscopic image in each case are calculated based on a brightness-corrected image obtained when the signal generator 33 and the image processor 34 process the image data of the endoscopic image in each case.

In other words, the recording portion 37 records therein information including a plurality of distribution characteristic values. Each of the distribution characteristic values recorded in the recording portion 37 is a distribution characteristic value of a brightness-corrected image. The brightness-corrected image represents a disease image corrected such that the brightness distribution in the analysis target area AA of the disease image is substantially uniform. Specifically, each of the distribution characteristic values recorded in the recording portion 37 is a distribution characteristic value of an extracted color component. The extracted color component is at least one of a red color component, a green color component, and a blue color component in a brightness-corrected image. The brightness-corrected image represents a disease image corrected such that the brightness distribution of the disease image is substantially uniform.

Although the distribution characteristic values in the analysis target area AA are herein recorded in the recording portion 37, the distribution characteristic values of the entire endoscopic image may also be recorded in the recording portion 37.

In addition, although the recording portion 37 is herein a memory in the video processor 3, it may be an external device 37X such as a server or the like connected to an external network 37Xa, such as the Internet, for example, as indicated by the dotted lines in FIG. 1. In other words, the video processor 3 may have a communication portion configured to communicate with the external device via the network, and may acquire template information from the external device that is used as the recording portion.

Moreover, although information of one case with respect to each disease is herein registered as template information in the recording portion 37, information of a plurality of cases with respect to each disease may be registered as template information in the recording portion 37. In such a case, an average value of a plurality of distribution characteristic values is registered in the recording portion 37 as a distribution characteristic value used to estimate a disease, and the average value is used to estimate a disease.

Furthermore, distribution characteristic values of partial images of the disease image may be registered in the recording portion 37. For example, if distribution characteristic values of a partial image of a polyp in an image of a gastric mucous membrane are registered in the recording portion 37 as template information regarding a gastric case, then it is possible to determine a disease from the distribution characteristic values of the partial image as a condition to be changed in a re-retrieval process to be described hereinafter.

The data registered as the template information may be image data processed such that a brightness distribution is substantially uniform or distribution characteristic values thereof.

Next, the configuration of the structured element designator 52 will be described hereinafter.

FIG. 6 is a block diagram illustrating the configuration of the structured element designator 52 of the signal generator 33.

As illustrated in FIG. 6, the structured element designator 52 of the signal generator 33 includes an edge detector 81, a closed curve edge detector 82, a size filter processor 83, a double closed curve edge detector 84, a double closed curve edge identifier 85, an analysis target identifier 86, an inscribed circle plotter 87, an inscribed circle average size calculator 88, and a structured element designation controller 89.

The structured element designator 52 is a processor for designating a structured element parameter to be used when the corrective image generator 53 generates a corrective image CP with respect to the endoscopic image IMG

The edge detector 81 detects edges from an image by applying an edge detecting filter to the image, for example.

The closed curve edge detector 82 detects edges representing closed curves from among the edges detected by the edge detector 81.

The size filter processor 83 performs a process for selecting only those closed curve edges that fall in a range wherein their sizes can be regarded as an element of interest, e.g., a range wherein the sizes of the closed curve edges can be regarded as a cilium in the intestinal tract, from among the closed curve edges detected by the closed curve edge detector 82.

The double closed curve edge detector 84 detects double closed curve edges, i.e., those closed curve edges each made up of an outer closed curve edge and an inner closed curve edge disposed inwardly of the outer closed curve edge, from among the closed curved edges detected by the closed curve edge detector 82 and selected by the size filter processor 83.

The double closed curve edge identifier 85 identifies the area inside the inner closed curve edge as a central area if (i) the color of the area inside the inner closed curve edge and (ii) the color of the area between the inner closed curve edge and the outer closed curve edge are different from each other among the double closed curve edges detected by the double closed curve edge detector 84.

At this time, if (i) the color of the area inside the inner closed curve edge is in a first color range corresponding to the central area of an element of interest and (ii) the color of the area between the inner closed curve edge and the outer closed curve edge is a second color range corresponding to the peripheral area of the element of interest, then the double closed curve edge identifier 85 identifies the area inside the inner closed curve edge as a central area. The second color range is different from the first color range. The first color range is a color range close to red, for example, if the element of interest is a cilium in the intestinal tract. The second color range is a color range close to white, for example, if the element of interest is a cilium in the intestinal tract.

A color difference is determined based on a difference as to at least one of hue, saturation, and luminance. Therefore, a color range is a range determined by a combination of one or two or more ranges of hue, saturation, and luminance. For example, a color range may be range determined by a combination of hue and saturation, or a color range may be a luminance range, i.e., a central area and a peripheral area may be distinguished from each other based on only luminance. If an element of interest is a cilium in the intestinal tract and a color range is a luminance range, then the first color range may be a slightly low luminance range and the second color range may be a luminance range higher than the first color range.

Furthermore, the double closed curve edge identifier 85 should more preferably identify the area inside the inner closed curve edge as a central area only if the sizes of the inner closed curve edge and the outer closed curve edge are determined to fall in the range wherein they can be regarded as an element of interest by the size filter processor 83.

The analysis target identifier 86 performs a process for identifying the inner closed curve of one or two or more double closed curve edges identified by the double closed curve edge identifier 85, as an analysis target.

The inscribed circle plotter 87 performs a process for plotting a circle inscribed in each analysis target.

The inscribed circle average size calculator 88 performs a process for calculating an average size of all inscribed circles plotted by the inscribed circle plotter 87, or an average value of their diameters herein.

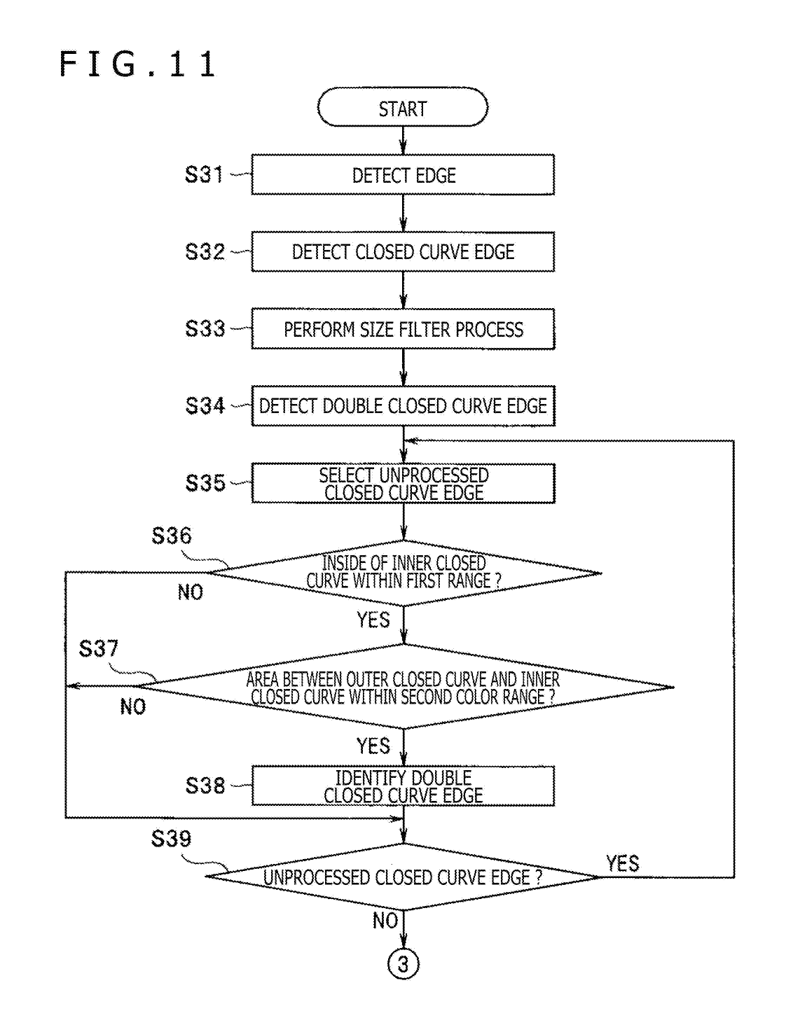

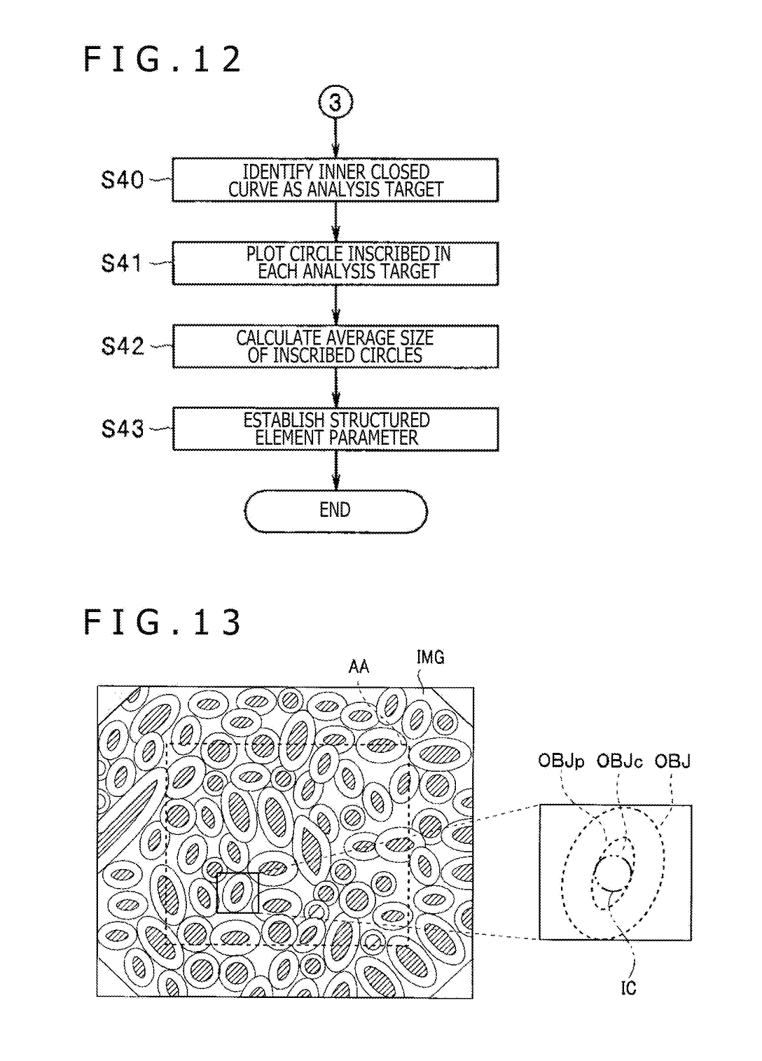

The structured element designation controller 89 controls the parts of the structured element designator 52, i.e., the edge detector 81, the closed curve edge detector 82, the size filter processor 83, the double closed curve edge detector 84, the double closed curve edge identifier 85, the analysis target identifier 86, the inscribed circle plotter 87, and the inscribed circle average size calculator 88, to perform an operation sequence to be described hereinafter with reference to FIGS. 11 and 12.

Using the endoscopic system 1 configured as described hereinbefore, the doctor inserts the insertion portion of the endoscope into the body of a patient and diagnoses the patient while viewing endoscopic images in the body that are displayed on the display device 5.

Prior to the diagnosis, the doctor enters various items of information regarding the patient, e.g., the patient's ID, name, age, clinical history, etc. into the video processor 3 using the input device of the video processor 3, not depicted, such as a control panel or the like. The entered patient information is recorded in the recording portion 37.

The doctor determines whether the patient has a disease or not while viewing endoscopic images. As described hereinafter, the video processor 3 can display on the display device 5 disease information DI similar to endoscopic images as information that the doctor can refer to in diagnosing the patient.

Operation

Next, operation of the endoscopic system 1 will be described hereinafter.

First, an overall processing sequence of the endoscopic system 1 will be described hereinafter. The user (i) places the distal-end hood on the distal end of the insertion portion, (ii) sets the endoscopic system 1 to the NBI mode, and (iii) makes a magnified observation of a small intestinal villus or a gastric mucous membrane

Overall Sequence

First, an overall sequence up to the extraction and outputting of disease information DI similar to an endoscopic image of a body will be described hereinafter.

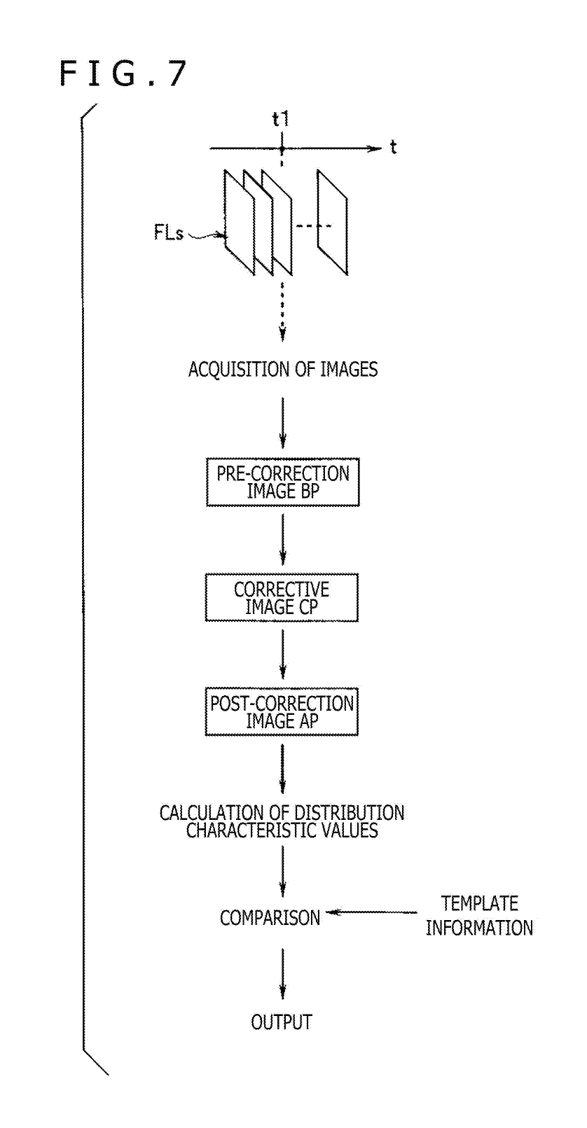

FIG. 7 is a diagram illustrating a process from the retrieval of disease information similar to a captured endoscopic image to the outputting of the retrieved disease information. The doctor, who is the user of the endoscopic system 1, enters information regarding a region to be examined into the video processor 3. For example, if a small intestinal villus is to be examined, then the doctor enters “small intestine” as information regarding a region to be examined into the video processor 3. If a gastric mucous membrane is to be examined, then the doctor enters “stomach” as information regarding a region to be examined into the video processor 3.

The doctor can acquire and record a still image by pressing the release button on the manipulator of the endoscope at a certain timing while making a magnified observation of a small intestinal villus or a gastric mucous membrane in the NBI mode.

In FIG. 7, if the release button is pressed at timing t1, then the controller 31 stores endoscopic images in a predetermined number of frames before and after or subsequent to timing t1 in the memory 32a of the image input portion 32.

The memory 32a of the image input portion 32 thus stores therein image data in a plurality of frames FLs sorted out according to a time sequence. An image that is free of a wide halation area is selected as an endoscopic image IMG from the frames FLs. In other words, the image input portion 32 is supplied with and acquires an endoscopic image IMG of the body at timing t1.

An analysis target area AA extracted from the acquired endoscopic image IMG is extracted as a pre-correction image BP. A corrective image CP is generated from the pre-correction image BP. The corrective image CP represents data for correcting a brightness distribution having an overall brightness gradient to restrain optical effects on the color components that make up the pre-correction image BP.

The signal generator 33 generates the corrective image CP using the endoscopic image IMG as the pre-correction image. The color components make up the endoscopic image IMG The endoscopic image IMG has an overall brightness gradient. The corrective image CP represents data for correcting a brightness distribution of the endoscopic image IMG so as to restrain optical effects on the color components.

A post-correction image AP is generated from the pre-correction image BP and the corrective image CP. The generated post-correction image AP is an image free of effects of an image brightness distribution due to the light distribution characteristics of illumination light, the inclination of the surface of the subject with respect to the optical axis of the observational optical system, the distance from the distal-end portion of the insertion portion to the observation target, or unevenness of the surface of the subject.

The image processor 34 generates the post-correction image AP that is a processed image generated by applying the corrective image CP as distribution correcting data to the endoscopic image IMG As described hereinbefore, the post-correction image AP is a brightness-corrected image where the brightness distribution is rendered substantially uniform.

Distribution characteristic values are calculated with respect to the post-correction image AP. The distribution characteristic value calculator 35 extracts color components in the post-correction image AP that is a processed image and determines distribution characteristic values.

The comparison information output portion 36 compares the distribution characteristic values calculated by the distribution characteristic value calculator 35 and the distribution characteristic values of the template information recorded in the recording portion 37. The comparison information output portion 36 outputs disease information DI of diseases where the distribution characteristic values coincide with each other or are similar to each other as disease candidate information CA.

Specifically, the comparison information output portion 36 compares (i) a red color component, a green color component, and a blue color component in the information of a plurality of distribution characteristic values recorded in the recording portion 37 and (ii) a red color component, a green color component, and a blue color component in the post-correction image AP with each other.

In other words, the comparison information output portion 36 compares the distribution characteristic values recorded in the recording portion 37 and the distribution characteristic values determined by the distribution characteristic value calculator 35 with each other. The comparison information output portion 36 outputs information regarding the state of the body from the result of the comparison.

The disease information DI included in the disease candidate information CA is displayed on the screen of the display device 5, and the doctor can make a diagnosis using the endoscopic image and the disease information as reference information.

Next, a process from the acquisition of an endoscopic image IMG to the presentation of disease information DI in the video processor 3 will be described hereinafter.

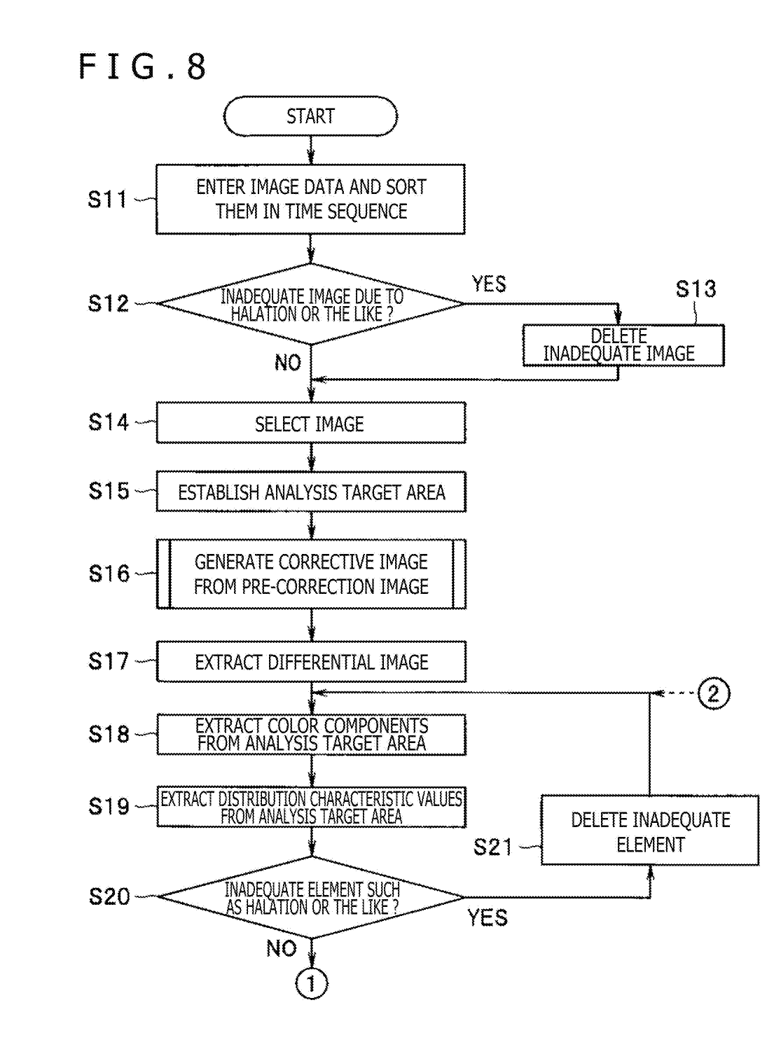

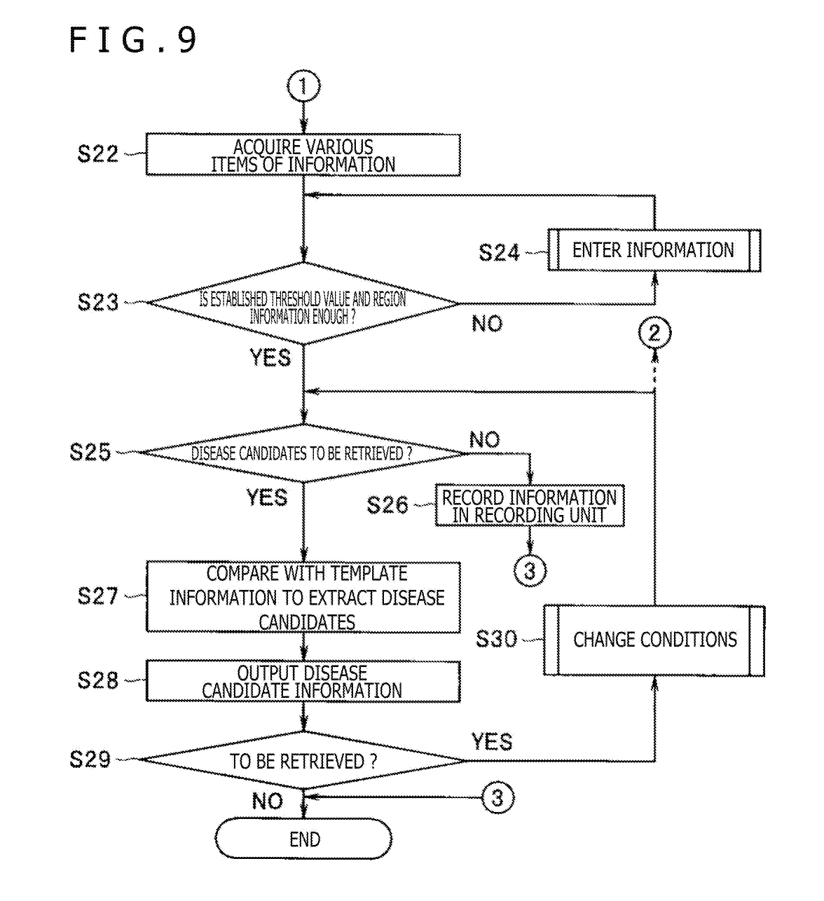

FIGS. 8 and 9 are flowcharts illustrating the process from the acquisition of an endoscopic image to the presentation of disease information.

Using the endoscopic system 1, the user who is the doctor observes an endoscopic image in the body which is being displayed on the display device 5.

The user sets the endoscopic system 1 to a magnified observation mode of NBI, and observes the inside of the body while an endoscopic image of NBI is being displayed on the display device 5. The endoscopic image obtained during the observation is stored in a mass storage such as a hard disk drive, not depicted.

When the user operates the release button, for example, an endoscopic image IMG is acquired. Specifically, when the user operates the release button, the controller 31 controls the image input portion 32 to store endoscopic images in a plurality of frames in the memory 32a at the timing of the pressing of the release button.

The process illustrated in FIGS. 8 and 9 is initiated when the user presses the release button. Under the control of the controller 31, the image input portion 32 sorts out image data of the body acquired chronologically from the endoscope 2 and stored in the memory 32a, according to a time sequence in step S11.

The image input portion 32 determines whether there is a frame of an inadequate image having a wide area of halation or the like among the frames of the image data that have been sorted out or not in step S12. Assuming that a pixel value is in a range of 0 to 255 and a threshold value is 230, for example, if a pixel area in which pixel values are 230 or larger takes up a predetermined proportion or larger in a frame, then the frame is determined as an inadequate image. In other words, the image input portion 32 determines whether each of the images sorted out in step S11 is an inadequate image not suitable to extract color component values therefrom or not. For example, if there are a predetermined number of pixels whose luminance values are a predetermined value or larger in a frame of image data, then since the image of that frame has a wide halation area, the image is determined as an inadequate image. Examples of inadequate areas include, in addition to an area suffering halation, an area where air bubbles are present, an area where the image is out of focus, and so on.

If there is an inadequate image in the frames of image data, Yes in step S12, then the image input portion 32 deletes the image data in one or two or more frames determined as an inadequate image from the image data in the frames obtained in step S11, in step S13.

Herein, the image input portion 32 compares the pixel values of pixels in each frame and a predetermined value as a predetermined threshold value with each other. The image input portion 32 determines the image in a frame as an inadequate image if the size of an area of halation or the like in the frame is equal to or larger than a predetermined value. However, the user may determine the image in such a frame as an inadequate image. For example, the image of a frame wherein the size of an area of halation or the like is equal to or larger than a predetermined value may be displayed on the screen of the display device 5, letting the user to determine whether the image is an inadequate image or not and delete any inadequate image frame by frame.

After step S12 or step S13, the image input portion 32 selects and acquires an image as a target for an image analysis from the image data in the frames free of an inadequate image, and outputs the acquired image to the signal generator 33 in step S14. In other words, the image input portion 32 selects one endoscopic image IMG from the images of the body acquired by the endoscope 2, except those images which include a predetermined value or more of inadequate elements not suitable to extract color component values therefrom.

Although one endoscopic image IMG is selected in step S14, a plurality of endoscopic images IMG may be selected.

Furthermore, images in a plurality of frames FLs are herein acquired upon the pressing of the release button. However, only one endoscopic image may be acquired.

The signal generator 33 establishes an analysis target area AA for the acquired image in step S15. The pre-correction image acquirer 51 of the signal generator 33 acquires an endoscopic image IMG as an image analysis target and establishes an analysis target area AA for the endoscopic image IMG The processing of step S15 constitutes an analysis target area establisher for establishing an analysis target area AA for the endoscopic image IMG Stated otherwise, the processing of step S15 constitutes an area extractor for determining a predetermined area in the endoscopic image IMG input from the image input portion 32 as an analysis target area AA.

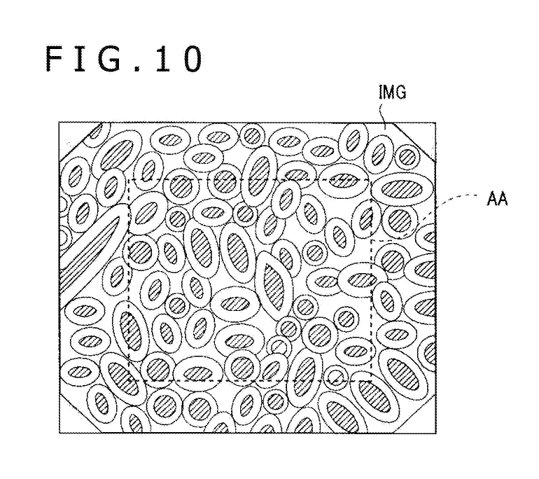

FIG. 10 is a view illustrating an analysis target area AA in an endoscopic image.

The analysis target area AA is pre-established in the endoscopic image IMG as a pixel area for accurately extracting color components therefrom. The analysis target area AA may be established by the user or may be pre-established by the endoscopic system 1.

Herein, the analysis target area AA is a rectangular area in the vicinity of the center which is in focus in the endoscopic image IMG and an area with little image distortions. In other words, the conditions for selecting an area (i) which is in focus and (ii) which has little image distortions are considered. If the user is to establish the analysis target area AA in the image, then conditions for selecting an area (iii) whose brightness is as uniform as possible and (iv) which is free of halation are added to selecting conditions for selecting an area (i) which is in focus and (ii) which has little image distortions.

In FIG. 10, one analysis target area AA is established in the endoscopic image IMG However, a plurality of analysis target areas AA may be established in the endoscopic image IMG.

The signal generator 33 generates a corrective image CP from a pre-correction image BP in step S16.

The pre-correction image BP is the endoscopic image IMG and is acquired by the pre-correction image acquirer 51. The signal generator 33 generates a corrective image CP with respect to the endoscopic image IMG.

The structured element designator 52 designates a structured element matching the endoscopic image IMG as an analysis target, and the corrective image generator 53 generates a corrective image CP with respect to the endoscopic image IMG using a designated structured element parameter.

Specifically, the signal generator 33 extracts a plurality of areas surrounded by closed curves extracted from the endoscopic image IMG and generates a corrective image CP as brightness distribution correcting data based on an average size of inscribed circles in the respective extracted areas.

If a plurality of analysis target areas AA are established in the endoscopic image IMG then the signal generator 33 generates a corrective image CP as brightness distribution correcting data for each of the analysis target areas AA established in the endoscopic image IMG.

Process for Designating a Structured Element

A process for designating a structured element with the structured element designator 52 will first be described hereinafter.

FIGS. 11 and 12 are flowcharts illustrating an example of the flow of the process for designating a structured element.

As described hereinbefore, the structured element designator 52 has the configuration illustrated in FIG. 6. The edge detector 81 extracts edge components to detect edges by applying an edge detecting filter to the analysis target area AA in step S31.

Next, the closed curve edge detector 82 detects edges representing closed curves from among the edges detected by the edge detector 81 in step S32.

Then, the size filter processor 83 calculates sizes, e.g., maximum diameters of the closed curves, an average diameter thereof, or areas surrounded by the closed curves, of the closed curve edges detected by the closed curve edge detector 82, and selects only those closed curve edges that fall in a range in which the calculated sizes can be regarded as an element of interest, e.g., a range wherein the sizes can be regarded as a cilium in the intestinal tract, in step S33.

The double closed curve edge detector 84 detects all double closed curve edges from among the closed curved edges that have passed through the size filter processor 83 in step S34.

The inner closed curve edges and the outer closed curve edges that make up the double closed curve edges are closed curve edges determined to fall in the range wherein their sizes can be regarded as an element of interest because they have gone through the processing of the size filter processor 83 in step S33.

The double closed curve edge identifier 85 selects one of the double closed curve edges detected by the double closed curve edge detector 84 in step S35, and determines whether the color of the area inside the inner closed curve edge, e.g., an average value of the color component values of the pixels, is in the first color range corresponding to the central area of an element of interest or not in step S36.

If the double closed curve edge identifier 85 determines that the color of the area inside the inner closed curve edge falls out of the first color range, then the double closed curve edge selected in step S36 is not identified as an element of interest, and the processing goes to step S39.

If the double closed curve edge identifier 85 determines that the color of the area inside the inner closed curve edge falls in the first color range, YES in step S36, then the double closed curve edge identifier 85 determines whether the color of the area between the outer closed curve edge and the inner closed curve edge of the selected double closed curve edge, e.g., an average value of the color component values of the respective pixels, falls in the second color range corresponding to the peripheral area of an element of interest or not in step S37.

If the double closed curve edge identifier 85 determines that the color of the area between the outer closed curve edge and the inner closed curve edge of the selected double closed curve edge falls in the second color range, YES in step S37, then the double closed curve edge identifier 85 identifies the double closed curve edge selected in step S35 as an element of interest.

If the double closed curve edge identifier 85 determines that the color of the area between the outer closed curve edge and the inner closed curve edge falls out of the second color range, then the double closed curve edge selected in step S35 is not identified as an element of interest, and the processing goes to step S39.

After step S38, the structured element designation controller 89 determines whether there is an unprocessed double closed curve edge, which is not processed by steps S36 through S38, among the double closed curve edges detected by the double closed curve edge detector 84 or not in step S39. If there is an unprocessed double closed curve edge, then the processing goes back to step S35, and a next double closed curve edge is processed by step S35.

If, in step S39, the structured element designation controller 89 determines that the processing from step S35 has been performed on all the double closed curve edges, No instep S39, then the analysis target identifier 86 identifies the inner closed curve of one or two or more double closed curve edges identified in step S38 as an analysis target in step S40.

The inscribed circle plotter 87 plots a circle inscribed in each analysis target in step S41.

The inscribed circle average size calculator 88 calculates an average size, i.e., an average value of diameters, of all the inscribed circles plotted in step S41, in step S42.

A value corresponding to the average size calculated in step S42 is established as a structured element parameter in step S43.

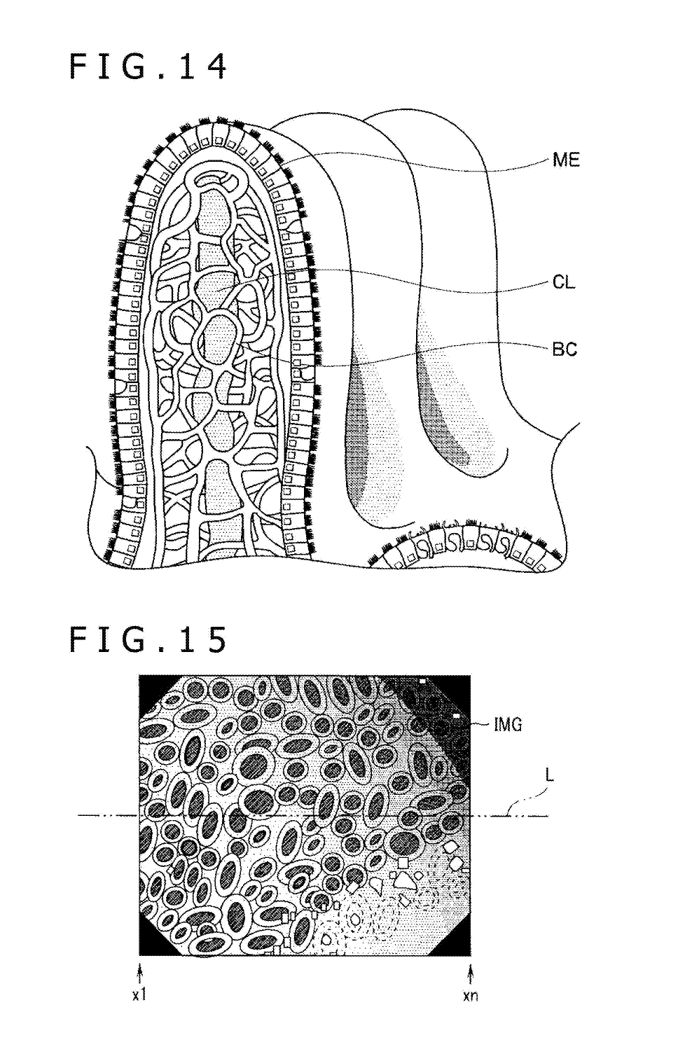

The significance of a specific structured element parameter will be described with reference to FIGS. 13 and 14.

FIG. 13 is a view illustrating at an enlarged scale an endoscopic image of a body and an element of interest. FIG. 14 is a view illustrating the structure of a cilium in the intestinal tract as an element of interest.

For example, in an endoscopic image IMG depicted in FIG. 13, double closed curve edges are identified as an element of interest in step S35. One double closed curve corresponds to one cilium in the intestinal tract.

As illustrated in FIG. 14, a cilium in the intestinal tract has a structure in which blood capillaries BC are distributed around a central lymphatic vessel CL located at the center and a mucosal epithelium ME is disposed outside of the blood capillaries BC, providing the surface of the cilium.

When such a cilium in the intestinal tract is observed at an enlarged scale by the NBI using light in a narrow wavelength band that can easily be absorbed by the hemoglobin in the blood, the blood capillaries BC are observed in a color different from the mucosal epithelium ME.

When an image of the cilium that is captured from above is observed, the image of the mucosal epithelium ME is observed as an annular peripheral portion OBJp and the image of the blood capillaries BC surrounded by the mucosal epithelium ME is observed as a central portion OBJc that is different in color from the mucosal epithelium ME. An element of interest OBJ is thus determined owing to the color difference between the central portion OBJc and the peripheral portion OBJp, as described hereinbefore.

In step S40 described hereinbefore, the inner closed curve of each of the double closed curve edges is identified as an analysis target, and in step S41, a circle inscribed in each inner closed curve is plotted. In FIG. 13, a circle indicated by the two-dot-and-dash line represents an inscribed circle IC in the inner closed curve plotted in step S41. For example, if the image of the central portion OBJc corresponding to the blood capillaries BC of the small intestinal villus is of an elliptical shape, then the diameter of the inscribed circle IC is represented by the length of the minor axis of the elliptical shape.

In step S42, an average size of all the inscribed circles IC is calculated, and in step S43, the calculated average size is established as a structured element parameter. In other words, the structured element parameter is of a value depending on the size of the analysis target.

Although the structured element designator 52 herein determines a structured element parameter based on the endoscopic image IMG as an analysis target, a preset value PP may be established as a structured element parameter, as indicated by the dotted line in FIG. 2.

For example, the user may designate in advance a value PP to be used in a magnified observation of a small intestinal villus, so that the value PP may be established as a structured element parameter. Moreover, since the size of a small intestinal villus varies depending on the distance between the subject and the distal-end portion of the insertion portion, a plurality of distance-dependent values PP may be prepared in advance, and the user may select one of them depending on the distance for an image analysis.

A structured element obtained in the manner described hereinbefore represents an optimum parameter value for detecting color components of a small intestinal villus as an analysis target. The structured element is herein set to a value not exceeding the average value of the diameters of the inscribed circles IC in the inner closed curves as an analysis target.

Since a structured element parameter is herein calculated from an image as an analysis target, a structured element is determined in real time with respect to an image from which color components are to be detected even if the distance between the distal-end portion of the insertion portion of the endoscope 2 and the subject varies.

The structured element is herein of a circular shape including a plurality of pixels around a pixel of interest, the shape of a range that defines a structured element may be other than the circular shape and may be changed depending on the analysis target.

### Process for Generating a Corrective Image

Next, a process for generating a corrective image with the corrective image generator 53 will be described hereinafter.

In step S16 illustrated in FIG. 8, a corrective image CP is generated using the structured element parameter designated by the structured element designator 52.

The corrective image generator 53 generates a corrective image CP with respect to the pre-correction image BP of the endoscopic image IMG by carrying out the image processing sequence to be described hereinafter.

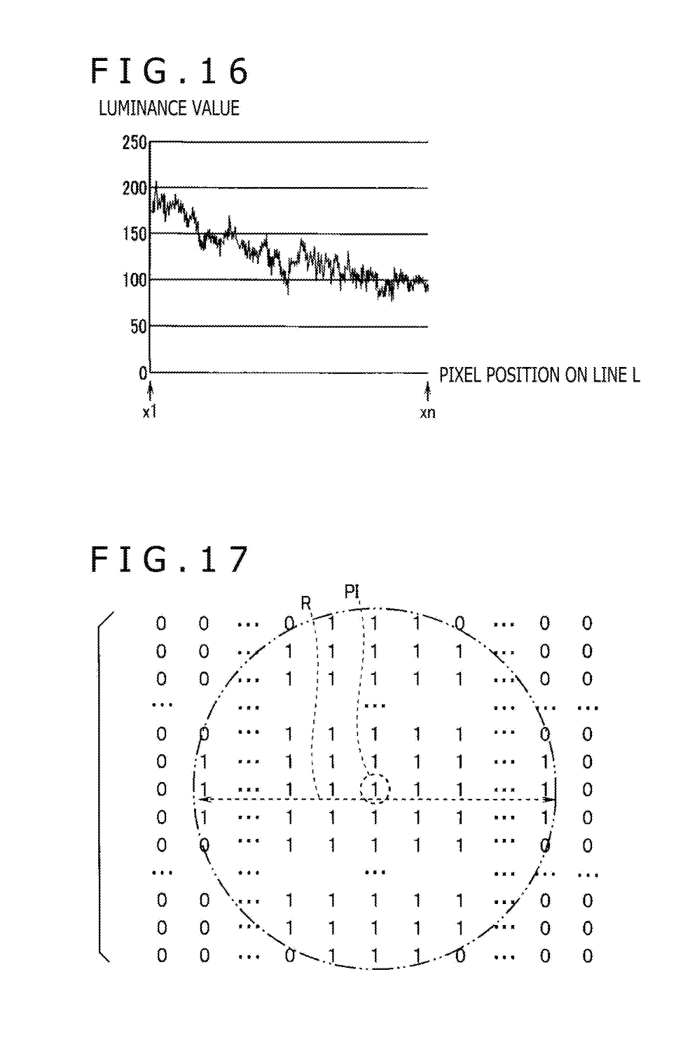

FIG. 15 is a diagram illustrating an example of an endoscopic image. FIG. 16 is a graph illustrating a luminance value distribution of a pixel group on a line L indicated by the two-dot-and-dash line in an analysis target area AA in the endoscopic image illustrated in FIG. 15. FIG. 16 illustrates a luminance value distribution of a pixel group in a range of a pixel xl to a pixel xn on the line L in the endoscopic image.

The endoscopic image illustrated in FIG. 15 has a brightness distribution in which the brightness decreases from a lower left portion toward an upper right portion. Therefore, as illustrated in FIG. 16, the luminance values of the pixel group on the line L are higher on the left side and lower on the right side.

When color components of an endoscopic image having a brightness distribution due to the light distribution characteristics of illumination light, the inclination of the surface of the subject with respect to the optical axis of the observational optical system, or the like, since the luminance value of each pixel is affected by the brightness distribution, it is difficult to accurately detect the luminance value of each of the color components.

For example, when disease information is to be retrieved based on the values of standard deviation of the luminance values of the color components of an endoscopic image, the disease information cannot accurately be detected as the brightness distribution of the endoscopic image is changed by the light distribution characteristics of illumination light, etc.

According to the present embodiment, therefore, a predetermined image processing sequence is carried out on a pre-correction image BP to correct the same, a post-correction image AP is generated, and the luminance values of the body are extracted from the color components of the post-correction image AP.

FIG. 17 is a diagram illustrating a structured element. FIG. 17 illustrates a luminance information acquisition range as a structured element parameter, used in an image processing sequence to be carried out on a pre-correction image BP.

In FIG. 17, the pixels within a range indicated by the dotted line represent a structured element in an image processing sequence that is performed on a pixel of interest PI using a contraction processing operation and an expansion processing operation to be described hereinafter. In FIG. 17, the pixels indicated by “1” are pixels of the structured element.

Herein, the structured element parameter represents a pixel group in the area of a circle having a diameter R with the pixel of interest PI at its center, and defines a range in which to acquire luminance information with respect to the pixel of interest. The diameter R represents the average value of the diameters of the inscribed circles IC in the inner closed curves as an analysis target. In FIG. 17, the pixel group in the circle indicated by the two-dot-and-dash line represents the structured element. The pixel group indicated by “1” includes the pixels in the range in which to acquire luminance information with respect to the pixel of interest. In other words, the structured element indicates the range in which to acquire luminance information with respect to the pixel of interest PI when a predetermined processing operation, to be described hereinafter, are carried out.

The structured element designator 52 outputs information of the pixel group corresponding to the diameter R as a structured element parameter to the corrective image generator 53.

The corrective image generator 53 performs the predetermined processing operation on the pixels ranging from the upper left pixel toward the lower right pixel, from the pixel at the left end toward the pixel at the right end and from the line on the uppermost side toward the line on the lowermost side in the analysis target area AA of the pre-correction image BP. The predetermined processing operation represents an opening process herein. The opening process includes a process for carrying out a certain number of, e.g., three, contraction processing operations, and thereafter carrying out as many expansion processing operations as the number of contraction processing operations.

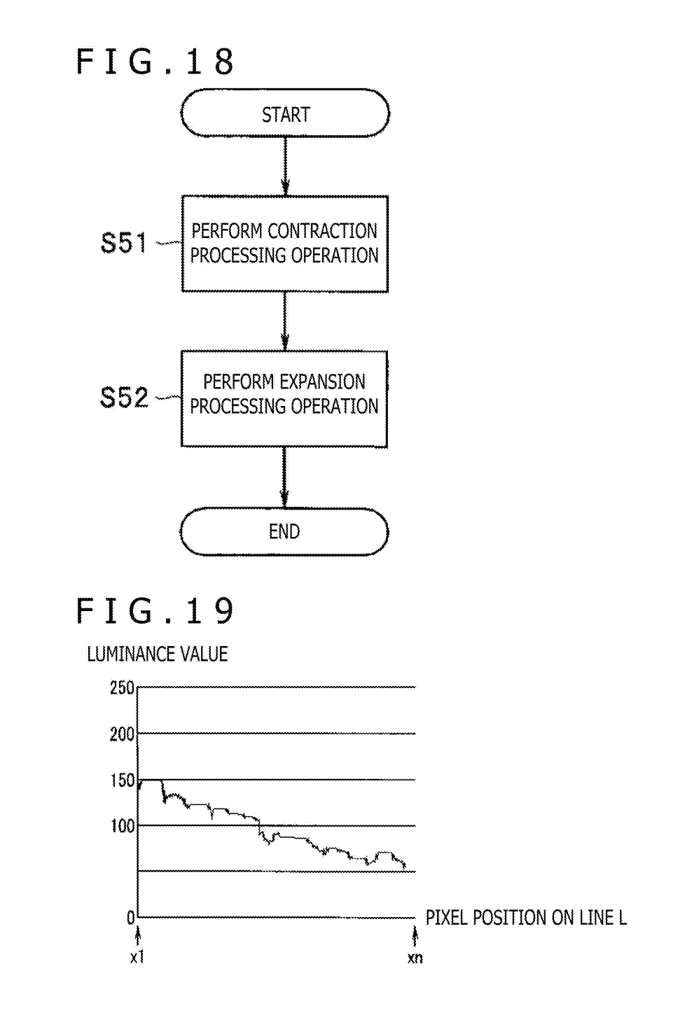

FIG. 18 is a flowchart illustrating an example of the flow of a process for generating a corrective image CP. The image processor 34 carries out a predetermined number of contraction processing operations on the pre-correction image BP in step S51 and thereafter carries out a predetermined number of expansion processing operations on the image processed by the contraction processing operations in step S52.

A contraction processing operation is a processing operation for setting the minimum value of the pixel values of a plurality of pixels in the structured element including the pixel of interest as the pixel value of the pixel of interest. An expansion processing operation is a processing operation for setting the maximum value of the pixel values of a plurality of pixels in the structured element including the pixel of interest as the pixel value of the pixel of interest.

When the pixel of interest PI is in a peripheral area of the pre-correction image BP, the area of the circle having the diameter R includes non-existing pixels. In such a case, contraction processing operations and expansion processing operations are carried out by performing a process in which operations are carried out on only the non-existing pixels or the non-existing pixels are replaced with an average luminance value within the area of the circle having the diameter R.

As described hereinbefore, the corrective image generator 53 carries out a contraction processing operation on the pixels ranging from the pixel at the left end of the pre-correction image BP toward the pixel at the right end thereof and from the line on the uppermost side toward the line on the lowermost side in the pre-correction image BP, using the structured element calculated by the structured element designator 52, and thereafter carries out two similar contraction processing operations. Thereafter, the corrective image generator 53 carries out an expansion processing operation on the pixels in the same order, and thereafter carries out two similar expansion processing operations, using the structured element calculated by the structured element designator 52. In other words, after having carried out three contraction processing operations, the corrective image generator 53 carries out an expansion processing operation on the pixels ranging from the upper left pixel toward the lower right pixel, and thereafter carries out two expansion processing operations.

The structured element used in the opening process represents the average size of the inner closed curves of the double closed curve edges corresponding to the small intestinal villi as an observation target, calculated by the structured element designator 52.

The corrective image CP is generated by performing the processing sequence described hereinbefore.

The corrective image generator 53 herein generates the corrective image CP according to the opening process as the predetermined processing operation. However, the corrective image generator 53 may generate a corrective image CP according to a closing process.

The closing process is a process in which one or more expansion processing operations are followed by as many contraction processing operations as the number of expansion processing operations.

In the opening process or the like described hereinbefore, expansion processing operations and contraction processing operations may be carried out on pixels that exclude those pixels that are halation pixels in a plurality of pixels in the structured element including the pixel of interest.

FIG. 19 is a graph illustrating a luminance value distribution of a pixel group in the generated corrective image CP. FIG. 19 illustrates a luminance value distribution of a pixel group on the line L in the analysis target area AA of the endoscopic image IMG illustrated in FIG. 15. The corrective image CP has a brightness distribution in which the brightness decreases from the left toward the right. Therefore, as illustrated in FIG. 19, the luminance values of the pixel group on the line L are higher on the left side and lower on the right side.

Referring back to FIG. 8, the pre-correction image input portion 61 of the image processor 34 is supplied with the pre-correction image BP, the corrective image input portion 62 is supplied with the corrective image CP generated by the signal generator 33, and the image differential extractor 63 extracts a differential image between the pre-correction image BP and the corrective image CP in the analysis target area AA in step S17.

In step S16, the corrective image CP is generated. In step S17, the differences between the pixels in the pre-correction image BP and the corresponding pixels in the corrective image CP are identified to extract a differential image, and a post-correction image AP is generated. The post-correction image AP is a brightness-corrected image in the analysis target area AA of the endoscopic image IMG that is established in step S15.

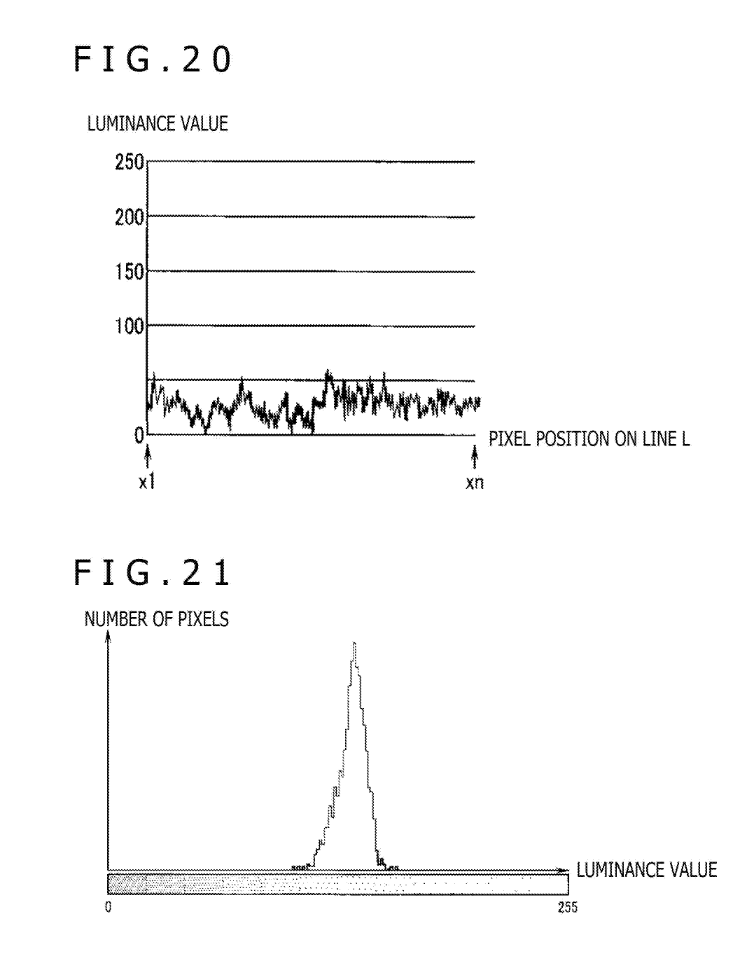

FIG. 20 is a graph illustrating a luminance value distribution of a pixel group in a generated post-correction image AP. FIG. 20 illustrates a luminance value distribution of a pixel group on the line L in the analysis target area AA of the endoscopic image IMG illustrated in FIG. 15. The post-correction image AP is an image wherein the brightness distribution is substantially uniform and luminance irregularities due to the light distribution characteristics of illumination light, etc. are suppressed, compared with the luminance value distribution illustrated in FIG. 16.

The color component value extractor 71 of the distribution characteristic value calculator 35 extracts color component values of each pixel of the post-correction image AP, e.g., an R component value, a G component value, and a B component value thereof, in step S18. Specifically, the color component value extractor 71 extracts the color component values, i.e., the R component value, the G component value, and the B component value, of each of the pixels that make up the post-correction image AP.

Thereafter, the total luminance value calculator 72 of the distribution characteristic value calculator 35 calculates a total luminance value of the color component values in the post-correction image AP extracted by the color component value extractor 71.

Then, the luminance value distribution characteristic value calculator 73 of the distribution characteristic value calculator 35 calculates and extracts a distribution characteristic value regarding each of the color component values of the pixels in the analysis target area AA of the post-correction image AP and a distribution characteristic value regarding the total luminance value in the analysis target area AA, calculated by the total luminance value calculator 72, in step S19.

If a plurality of endoscopic images are selected in step S14, then the color component value extractor 71 may extract color components in the analysis target areas of the endoscopic images in step S18, and the luminance value distribution characteristic value calculator 73 may calculate distribution characteristic values in the respective selected endoscopic images and may use an average value of the calculated distribution characteristic values as a distribution characteristic value in step S19.

According to the present embodiment, as described hereinbefore, the “distribution characteristic value” is determines as a standard deviation of a plurality of pixel value distributions in the analysis target area AA. In other words, the distribution characteristic value calculator 35 extracts color components in the analysis target area AA of the post-correction image AP which is a processed image and determines a distribution characteristic value.

FIG. 21 is a histogram of luminance values in the post-correction image AP.

FIG. 21 is a histogram whose horizontal axis represents luminance values in a target area of the post-correction image AP and whose vertical axis represents the numbers of pixels corresponding to the luminance values. The luminance value distribution illustrated in FIG. 21 is a luminance value distribution of one of three color components from which the effect of luminance irregularities has been removed.

The distribution characteristic value calculator 35 determines whether there are inadequate elements, i.e., inadequate pixels, suffering halation, air bubbles, etc. in the post-correction image AP from the endoscopic image IMG or not in step S20. Assuming that a pixel value is in a range of 0 to 255 and a threshold value is 100, for example, it is determined that pixels whose pixel values are equal to or larger than 100 in the post-correction image AP which is a differential image are inadequate pixels.

If there are inadequate elements, i.e., inadequate pixels, suffering halation or the like in the post-correction image AP from the endoscopic image IMG then the distribution characteristic value calculator 35 excludes the inadequate pixels from the post-correction image AP in step S20, and carries out the processing of steps S18 and S19 on the pixel group from which the inadequate elements have been excluded. In other words, the distribution characteristic value calculator 35 extracts a distribution characteristic value while excluding inadequate elements not suitable to extract color component values from the post-correction image AP.

If it is determined in step S20 that there are inadequate elements, then a message or the like indicating that there are inadequate elements in the post-correction image AP may be displayed on the display device 5, prompting the user to make a choice as to whether the processing of step S21 is to be carried out or not.

Next, the information controller 38 acquires various items of information including patient information, information regarding a region to be examined, determination parameter information, and so on in step S22. The patient information and the information regarding a region to be examined are entered from the input device, not depicted, by the user prior to the examination. The determination parameter information may include a threshold value for estimating or determining a disease, and may be acquired by reading preset default information from the RAM or the like or may be entered by the user.

The information controller 38 determines whether the set information such as the acquired patient information, the determination parameter information, etc. is sufficient as information required to extract disease candidates, to be described hereinafter, and display the disease candidates or not in step S23. Stated otherwise, it is determined whether there is available all information required to extract disease candidates and display the disease candidates or not.

If the set information such as the acquired patient information, the determination parameter information, etc. is not sufficient, NO in step S23, then the information controller 38 performs a process for entering information in step S24.

The entering process is carried out by displaying, on the screen of the display device 5, a message for prompting the user to enter insufficient information or lacking information, and an input field for entering the information, so that the user will enter the information.

If the set information such as the acquired patient information, the determination parameter information, etc. is sufficient, YES in step S23, then the information controller 38 determines whether to retrieve disease candidates or not in step S25. If not to retrieve disease candidates, NO in step S25, then the distribution characteristic value calculator 35 sends information of the body, i.e., an endoscopic image, an image processed so that the brightness distribution has been made substantially uniform, a distribution characteristic value, etc. to the information controller 38, which records the information as disease information in the recording portion 37 in step S26. If to retrieve disease candidates, YES in step S25, then the information controller 38 controls the comparison information output portion 36 to function to compare the distribution characteristic value information DC of the post-correction image AP with the template information to extract disease candidates in step S27.

In the comparison information output portion 36, the distribution characteristic value input portion 74 receives the distribution characteristic value information DC from the distribution characteristic value calculator 35. The disease information checker 75 checks the distribution characteristic value information DC from the distribution characteristic value input portion 74 against the distribution characteristic values of a plurality of disease information contained in the template information recorded in the recording portion 37, and calculates a degree of coincidence with disease candidates of the template information.

In step S19, the distribution characteristic values of the luminance value distributions of the three color components RGB of the endoscopic image IMG and the distribution characteristic value of the sum thereof are calculated, and in step S27, these four calculated distribution characteristic values are compared with the distribution characteristic values of the luminance value distributions of the three color components RGB of each disease information DI and the distribution characteristic value of the sum thereof. However, the color components to be compared in step S27 may be selected by the user. This is because some diseases may have distribution characteristic values largely different with respect to certain color components, and the user may select color components of distribution characteristic values used to extract disease candidates.

The disease candidate determiner 76 determines disease candidates to be output based on the information regarding the degree of coincidence of each of the disease candidates calculated by the disease information checker 75.

For example, one or more disease candidates with a high degree of coincidence are selected, and one or more disease candidates to be output are determined.

The information output portion 77 generates disease candidate information CA determined by the disease candidate determiner 76, and outputs the generated disease candidate information CA to the display device 5 in step S28.

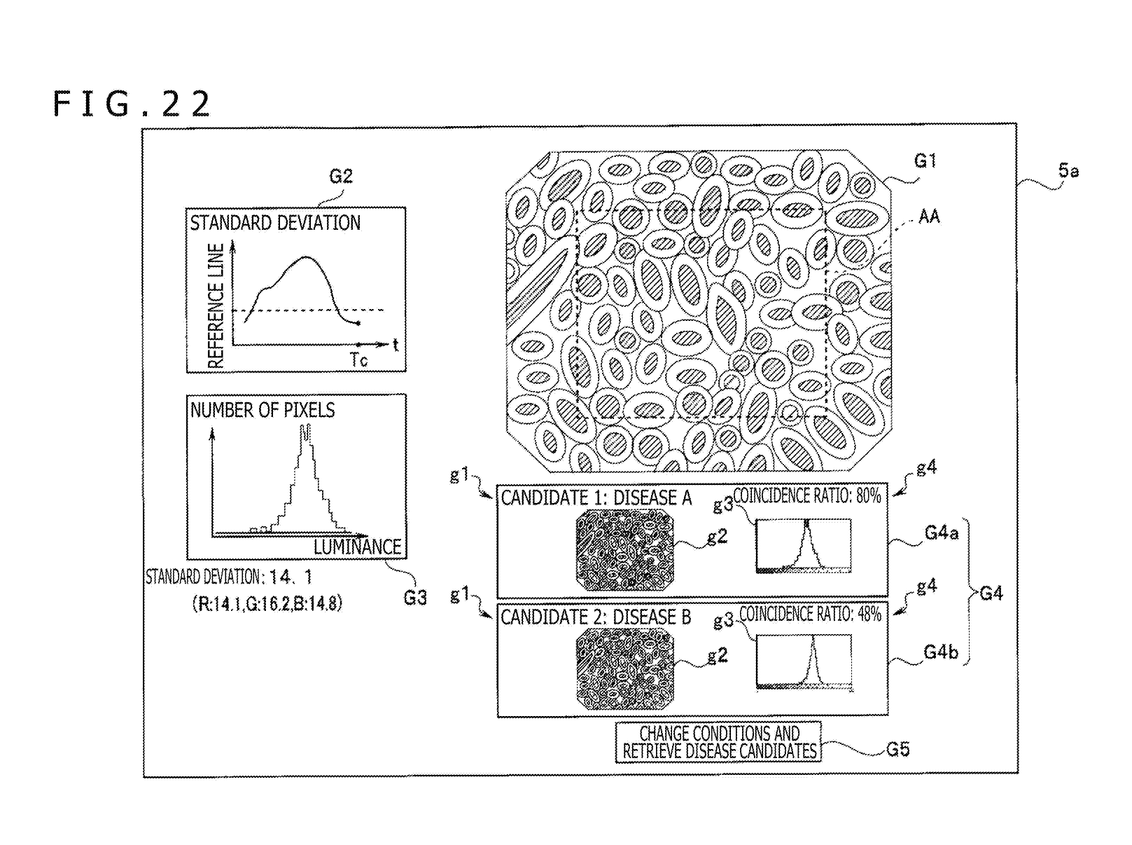

FIG. 22 is a diagram illustrating a displayed example of disease candidate information displayed on the display device 5.

The process for outputting the disease candidate information in step S28 is a process for generating an image as illustrated in FIG. 22. FIG. 22 illustrates by way of example body information during a magnified observation and a user interface indicating disease candidate information, displayed on the display device 5.

While the user is performing an endoscopic examination, a live image is displayed on a display screen 5a of the display device 5. When the release button is pressed during the endoscopic examination, the processing sequence illustrated in FIGS. 8 and 9 is carried out, and a disease candidate presentation image as illustrated in FIG. 22 is displayed on the display screen 5a of the display device 5 by the processing of step S28. The image displayed on the display screen 5a includes a live image display portion G1, a standard deviation graph display portion G2, a luminance value distribution display portion G3 for displaying a distribution of luminance values in the live image, a disease candidate display portion G4 for displaying disease candidate information, and a re-retrieval button G5.

The live image display portion G1 is an area for displaying a life image of the endoscopic image obtained from the endoscope 2. In other words, the live image display portion G1 displays a real-time endoscopic image. The live image display portion G1 also displays the analysis target area AA indicated by the dotted line.

The processing of steps S11 through S19 is also performed on endoscopic images that are input in real time by way of background processing.

The standard deviation graph display portion G2 is an area for displaying changes in a standard deviation of a luminance value distribution of a plurality of pixels in the analysis target area AA of the endoscopic image as time t elapses. The standard deviation in the standard deviation graph display portion G2 represents a standard deviation of a luminance value distribution regarding a sum of color component values of a plurality of pixels in the analysis target area AA that are sampled at a plurality of timings including the processing timing of step S19 executed by way of background processing, e.g., at timings each of about one second. The standard deviation during a predetermined period in the past from present time Tc is herein displayed.

The luminance value distribution display portion G3 displays, in real time, a luminance value distribution and a standard deviation of the live image displayed in the live image display portion G1. The luminance value distribution displayed in the luminance value distribution display portion G3 is also determined based on the luminance value of a sum of the sampled color component values about the post-correction image AP at a plurality of timings including the processing timing of step S19 executed by way of background processing. The luminance value distribution display portion G3 displays the behavior of the luminance value distribution in real time.

The standard deviation displayed in the standard deviation graph display portion G2 and the luminance value distribution displayed in the luminance value distribution display portion G3 may be a standard deviation and a luminance value distribution with respect to a color component designated by the user, e.g., either one of the colors RGB.

The disease candidate display portion G4 displays information of one or two or more disease candidates. Information G4a, G4b of two high-level disease candidates where the degree of coincidence with the distribution characteristic values is high is herein displayed on the display screen 5a.

The information G4a, G4b of the disease candidates displayed on the display screen 5a represents information included in the disease candidate information CA that is part of the template information, and includes a disease candidate name display portion g1, a disease region endoscopic image display portion g2, a disease candidate distribution graph display portion g3, and a degree-of-coincidence information display portion g4.

The disease candidate name display portion gl displays candidate ranks and disease candidate names. Disease A and disease B are herein displayed as examples of first and second candidates for a gastric disease.

The disease region endoscopic image display portion g2 displays disease images included in the template information. A disease image of the first candidate and a disease image of the second candidate are herein displayed.

The disease candidate distribution graph display portion g3 displays luminance value distributions of disease images included in the template information. A luminance value distribution of the disease image of the first candidate and a luminance value distribution of the disease image of the second candidate are herein displayed.

The degree-of-coincidence information display portion g4 displays coincidence ratios of the distribution characteristic values of disease images included in the template information and the distribution characteristic value of the endoscopic image. The degrees of coincidence between the distribution characteristic value in the analysis target area AA of the endoscopic image and the distribution characteristic value of the disease image of the first candidate and the distribution characteristic value of the disease image of the second candidate are herein displayed.

As described hereinbefore, the comparison information output portion 36 outputs information of the degrees of coincidence between a plurality of distribution characteristic values from the recording portion 37 and the distribution characteristic value determined by the distribution characteristic value calculator 35. The comparison information output portion 36 also outputs a graph indicating a distribution of color components about the distribution characteristic value determined by the distribution characteristic value calculator 35, and the disease candidate information CA for displaying the information of the degrees of coincidence on the display device 5 to the display device 5. The comparison information output portion 36 displays disease images relating to the degrees of coincidence on the display device 5.

Since the disease candidate display portion G4 displays on the display screen 5a information of disease candidates estimated based on the distribution characteristic value of the endoscopic image that is acquired when the release button is pressed, the user can use the displayed information as a reference in determining a disease in the diagnosis.

The recording portion 37 may also register therein information regarding the identification (ID), age, date of examination, medical history, and family medical history of the patient from which the disease image is taken, with respect to disease images used as the template information in the recording portion 37, and the registered information may be displayed together in the disease candidate display portion G4.

Furthermore, the user information illustrated in FIG. 22 may also be able to display an observation mode in which a disease candidate can easily be viewed, information such as a guideline relative to the classification and definition of the disease candidate, and information regarding an external disease information site.

The user may want to change determining conditions such as various threshold values and re-retrieve disease candidates. For example, if a displayed disease candidate is not a disease that the user has anticipated, then the user may want to (i) change a determination parameter, (ii) extract a disease candidate by using only one or two of the color components RGB used to extract a disease candidate, or (iii) extract a disease candidate by using only those pixels whose luminance values are smaller than a predetermined value of 100, for example. Inasmuch as a signal representing a color component R contains more information regarding blood vessels in deep body regions, the user may want to extract a disease candidate by using only the color component R in an effort to estimate a disease based on image information from a deep body region.

If the user is to change such conditions and re-retrieve disease candidates, the processing goes to step S25.

Moreover, the user may want to limit the analysis target to a portion in the analysis target area and extract disease candidates with respect thereto again. For example, if a distribution characteristic value is to be obtained from a certain portion of a polyp in the analysis target area and disease candidates are to be re-retrieved with respect thereto, then the processing goes to step S18 as indicated by the dotted line in order to limit the portion in the analysis target area as the analysis target area.

The re-retrieval button G5 is a button used to re-retrieve disease candidates under changed retrieving conditions.

The information controller 38 determines whether the user has issued a re-retrieval instruction or not in step S29. If the user has issued a re-retrieval instruction, YES in step S29, then the information controller 38 carries out a condition changing process in step S30.

The condition changing process is carried out by displaying a condition changing screen or window on the screen of the display device 5 to allow the user to change the setting of a determining parameter, for example.

After the condition changing process, the processing of step S25 is carried out to extract disease candidates under the changed conditions.

If the user has not issued a re-retrieval instruction, NO in step S29, then the process for extracting disease candidates as described hereinbefore is ended.

Differences between luminance value distributions of diseases and differences between standard deviations of luminance value distributions of diseases will be described hereinafter.

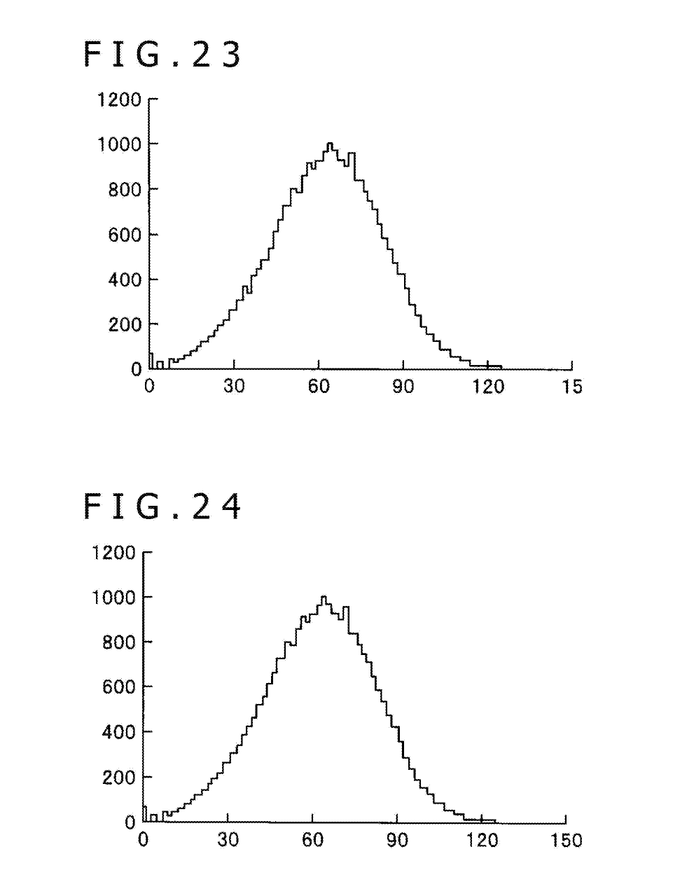

FIGS. 23 through 28 are histograms representing luminance values of color components in the analysis target area AA of endoscopic images and numbers of pixels corresponding to the luminance values.

FIG. 23 is a histogram representing luminance values produced by standardizing sums of luminance values of three color components RGB in an endoscopic image of a normal gastric mucous membrane and the numbers of pixels corresponding to the luminance values.

FIG. 24 is a histogram representing luminance values of a color component R in the endoscopic image of the normal gastric mucous membrane and the numbers of pixels corresponding to the luminance values.

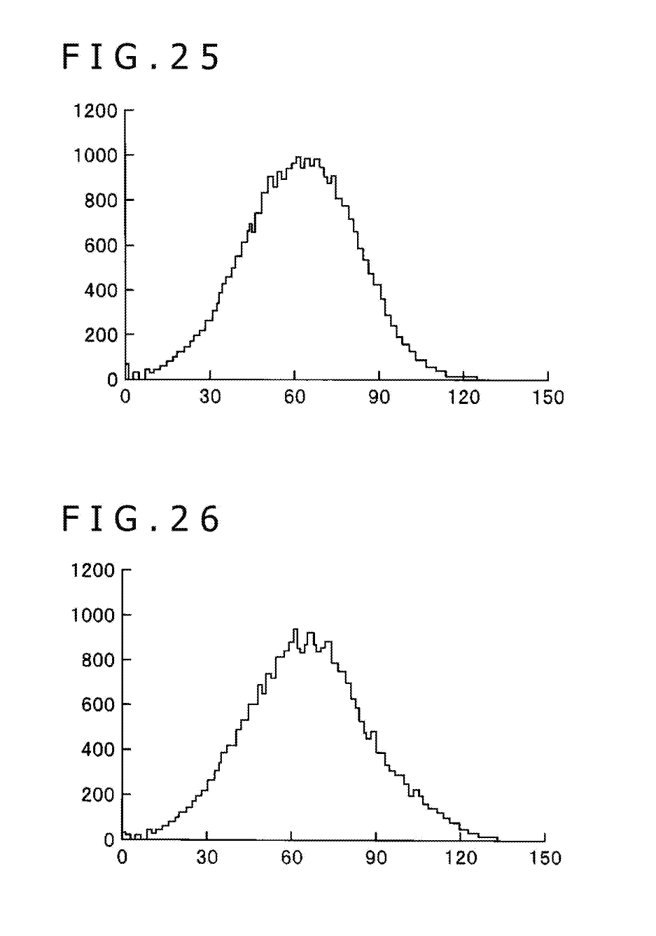

FIG. 25 is a histogram representing luminance values of a color component G in the endoscopic image of the normal gastric mucous membrane and the numbers of pixels corresponding to the luminance values.

FIG. 26 is a histogram representing luminance values produced by standardizing sums of luminance values of three color components RGB in an endoscopic image of a gastric mucous membrane suffering a disease A and the numbers of pixels corresponding to the luminance values.

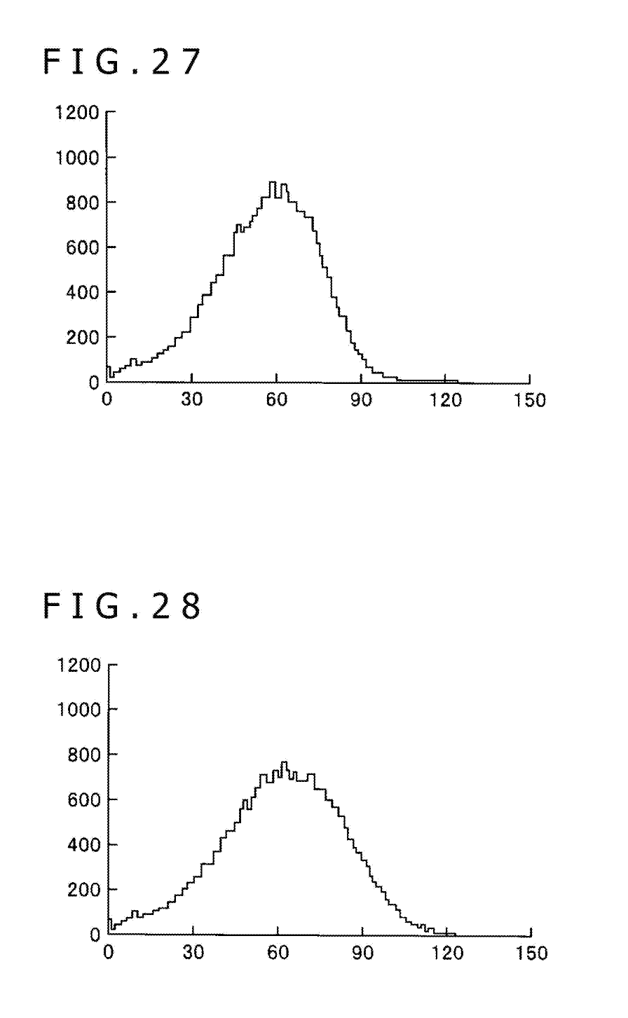

FIG. 27 is a histogram representing luminance values of a color component R in an endoscopic image of a gastric mucous membrane suffering the disease A and the numbers of pixels corresponding to the luminance values.

FIG. 28 is a histogram representing luminance values of a color component G in the endoscopic image of the gastric mucous membrane suffering the disease A and the numbers of pixels corresponding to the luminance values.

As illustrated in FIGS. 23 through 28, the standard deviation of the sum with respect to the normal mucous membrane was 20.9, and the standard deviation of the sum with respect to the mucous membrane suffering the disease A was 21.8. The standard deviation of the color component R with respect to the normal mucous membrane was 20.3, and the standard deviation of the color component R with respect to the mucous membrane suffering the disease A was 17.7. The standard deviation of the color component G with respect to the normal mucous membrane was 19.8, and the standard deviation of the color component G with respect to the mucous membrane suffering the disease A was 20.4.

The standard deviation has thus different values with respect to the normal mucous membrane and the mucous membrane suffering the disease A. In particular, the standard deviation of the sum of the color components RGB with respect to the mucous membrane suffering the disease A is 0.9 higher than the standard deviation of the sum with respect to the normal mucous membrane, and the standard deviation of the color component G with respect to the mucous membrane suffering the disease A is 0.6 higher than the standard deviation of the color component G with respect to the normal mucous membrane, though the standard deviation of the color component R with respect to the mucous membrane suffering the disease A is 2.6 lower than the standard deviation of the color component R with respect to the normal mucous membrane.

Similarly, it has been found that standard deviations are more different with respect to the color components than the sum, depending on diseases.

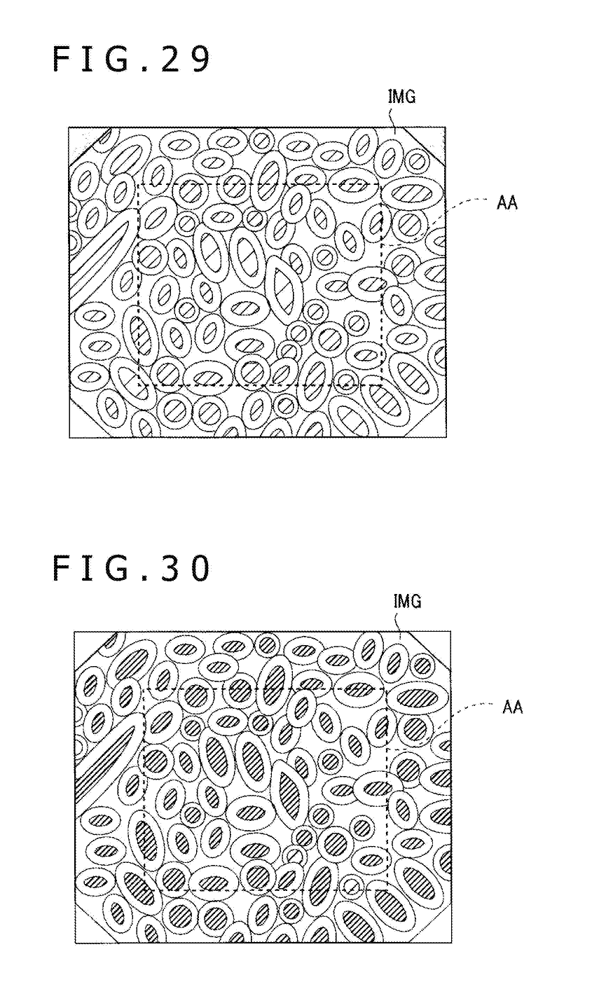

FIG. 29 is a diagram illustrating an example of an endoscopic image where the standard deviation of a luminance value distribution is small. FIG. 30 is a diagram illustrating an example of an endoscopic image where the standard deviation of a luminance value distribution is large.

As illustrated in FIG. 29, the endoscopic image where the standard deviation of a luminance value distribution is small is an image where the differences between brightness and darkness are small as a whole.

As illustrated in FIG. 30, the endoscopic image where the standard deviation of a luminance value distribution is small is an image where the differences between brightness and darkness are large as a whole.

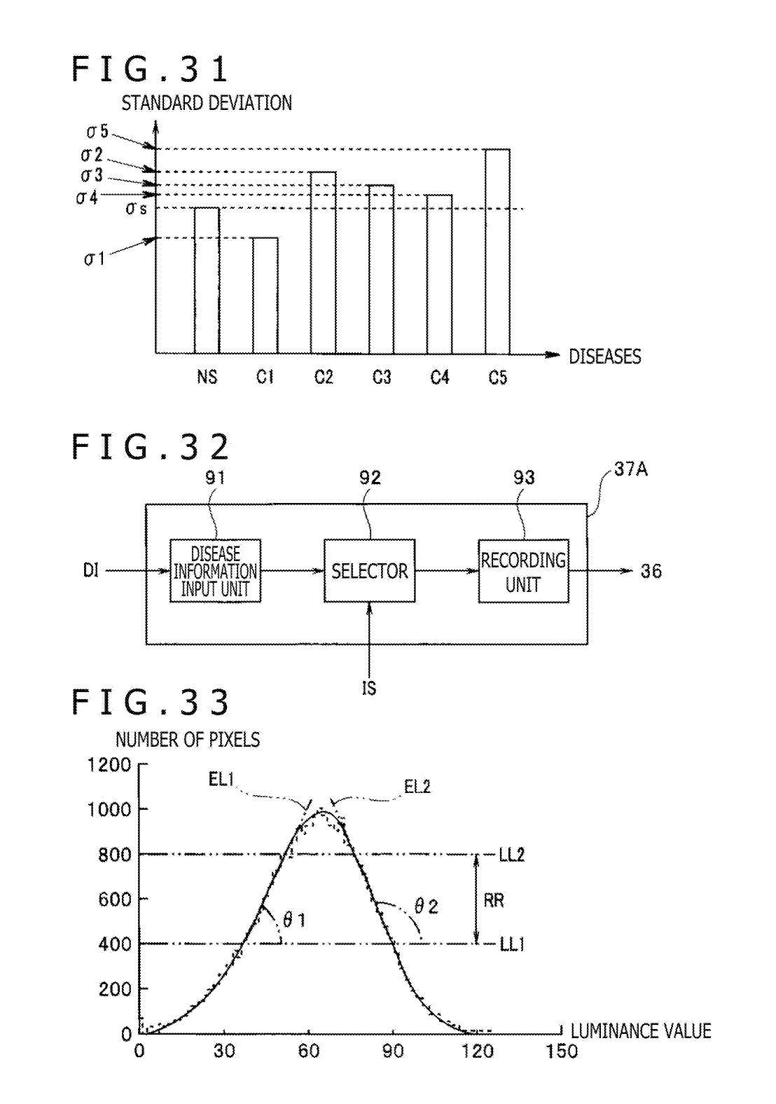

FIG. 31 is a graph illustrating the differences between standard deviations with respect to respective diseases. FIG. 31 illustrates standard deviations of the sums of three luminance values of RGB.

As illustrated in FIG. 31, the standard deviation is σs for the normal gastric mucous membrane (NS), whereas the standard deviations are σ1, σ2, σ3, σ4, and σ5 respectively for a disease A (C1), a disease B (C2), a disease C (C3), a disease D (C4), and a disease E (C5), and are different from the standard deviation σs for the normal gastric mucous membrane.

Moreover, the standard deviation of the luminance value distribution of RGB is different between the normal mucous membrane and each of the diseases and also between a plurality of diseases.

Consequently, the distribution characteristic value of a luminance value distribution of the color components of the endoscopic image, i.e., the standard deviation, is compared with the distribution characteristic values of luminance value distributions of the color components of a plurality of disease images, and disease candidates are extracted based on the degrees of coincidence, so that the disease of the region being examined can be estimated.

According to the embodiment described hereinbefore, there are provided an image analyzing apparatus, an image analyzing system, and a method of operating an image analyzing apparatus, which are capable of accurately retrieving an image similar to a medical image including information of obtained colors while restraining the effects of luminance irregularities in endoscopic images.

Although the disease of the region being examined is herein estimated using a standard deviation as a distribution characteristic value, the disease of the region being examined may be estimated based on the variance of a luminance value distribution.

According to the embodiment described hereinbefore, the image analyzing apparatus is applied to a small intestinal villus or a gastric mucous membrane. However, the image analyzing apparatus according to the present embodiment is also applicable to the extraction of disease candidates for other organs such as an esophagus, a large intestine, and so on than a small intestinal villus and a gastric mucous membrane.

For example, the image analyzing apparatus according to the present embodiment is applicable to the extraction of disease candidates for small intestinal tumor, Crohn's disease, gastrointestinal hemorrhage of unknown origin, and so on in the small intestine, the extraction of disease candidates for ulcerative colitis, colorectal cancer, Crohn's disease, and so on in the large intestine, and the extraction of disease candidates for chronic gastritis, gastric ulcer, acute gastritis, and so on in the esophagus.

Furthermore, the image analyzing apparatus according to the present embodiment is applicable to not only the extraction of disease candidates, but also the determination of a state in a diagnosis.

For example, the image analyzing apparatus can be used to diagnose a change in a Peyer's patch in the small intestine, a pit pattern in the large intestine, whether there is Helicobacter pylori in the stomach or not, the state of a Barrett esophagus, or the like.

A predetermined load, i.e., a predetermined action, may be imposed on the body, and the endoscope 2 may chronologically acquire images of the body across the timing of imposing the load or action. Disease candidates may be extracted based on endoscopic images after the load or action is imposed or based on endoscopic images across the timing of imposing the load or action.

The “predetermined action” imposed on the body, referred to hereinbefore, represents, for example, the administration of a liquid medicine to the body. The “liquid medicine” represents, for example, a physiological saline solution, dextrose, or liquid fat such as fat emulsion or the like, and one specific example of the load or action is a spraying of dextrose.

The “predetermined action” referred to hereinbefore is not limited to the administration of a liquid medicine, but may be an intravenous injection, the delivery of air into a body cavity, or an action for bringing a treatment tool or an endoscope itself into physical contact with the inside of a body.

According to the embodiment described hereinbefore, a luminance value distribution of color components of a body can be obtained using an image free of the effects of an image brightness distribution due to the light distribution characteristics of illumination light, the distance from the distal-end portion of the insertion portion to the observation target, or the like.

Particularly, even if the body is not fixed in place or the distance between the body and the distal-end portion of the insertion portion can easily be changed as in the magnified observation mode, a luminance value distribution of color components of the body can be obtained using an image free of the effects of an image brightness distribution due to the light distribution characteristics of illumination light.

In the example described hereinbefore, a structured element is determined in real time based on an image. However, the user may view an image and enter or select the distance from the distal-end portion of the insertion portion to the subject, so that a structured element depending on the distance may be used.

Furthermore, the image analyzing apparatus according to the embodiment described hereinbefore has the NBI mode and the normal-light observation mode. However, the embodiment described hereinbefore is also applicable to endoscopic images of a body that are obtained in modes other than the modes hereinbefore, e.g., other special light observation modes such as a fluorescence observation, an infrared observation, and so on.

Next, modifications of the embodiment described hereinbefore will be described hereinafter.

Modification 1

In the embodiment described hereinbefore, disease information as template information is recorded in advance in the recording portion 37. However, disease information may be added to the recording portion 37.

FIG. 32 is a block diagram illustrating the configuration of a recording portion according to Modification 1.

A recording portion 37A according to Modification 1 includes a disease information input portion 91 and a selector 92 in addition to a recording portion 37.

The recording portion 37 has various items of disease information recorded in advance therein. There are instances wherein the accuracy of disease estimation should be increased by adding disease information thereby to increase the number of diseases to be estimated and to use a plurality of items of information regarding the same diseases. According to Modification 1, template information can be added to the recording portion 37.

The disease information input portion 91 is an input portion configured to enter disease information DI. Disease information DI is entered into the disease information input portion 91 automatically or manually from a network or a portable recording medium.

The selector 92 is operated by the user to perform a process for selecting disease information DI to be registered as template information in the recording portion 37 from among the entered disease information DI.

Disease information DI to be registered as template information in the recording portion 37 is selected according to an instruction IS from the user and additionally registered in the recording portion 37. Disease information selected to be registered includes region information that identifies regions including small intestine, stomach, large intestine, and so on and endoscopic images, and distribution characteristic values of luminance value distributions calculated from luminance values of color components of the endoscopic images are registered together.

Template information can be increased to increases the accuracy of disease estimation by using the recording portion 37A.

Modification 2

According to the embodiment described hereinbefore, the recording portion 37 records therein data of a standard deviation or variance as a distribution characteristic value with respect to each disease, and disease candidates are extracted based on the recorded distribution characteristic values. In addition to the distribution characteristic values, waveform data of a luminance value distribution with respect to each disease may be recorded, and disease candidates may be extracted in view of the degree of coincidence of waveforms or information as to similarity. In other words, diseases may be estimated from the shape of waveforms based on the waveform data of luminance value distributions.

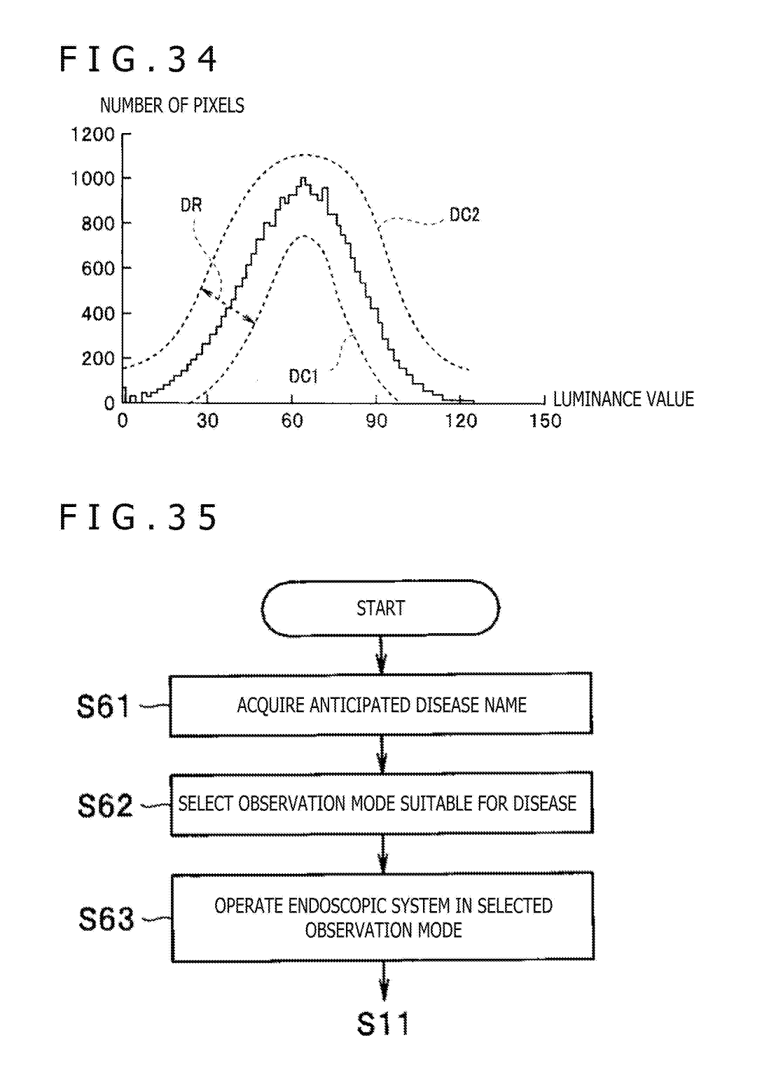

FIGS. 33 and 34 are graphs illustrating examples of waveform data of a luminance value distribution of a certain color according to Modification 2. FIGS. 33 and 34 are histograms each having a horizontal axis representing luminance values in the analysis target area AA of the post-correction image AP and a vertical axis representing the numbers of pixels corresponding to the luminance values.

There is an instance wherein a disease should be estimated based on the shape of a waveform in a certain range in the waveform of a luminance value distribution. In such an instance, the user designates a range in the waveform and shape parameters of the waveform as retrieving conditions in steps S25 and S28.

For example, in FIG. 33, the user designates a range RR from the number LL1 of pixels to the number LL2 of pixels as a range in the waveform and also designates gradients θ1, θ2 of the waveform in the designated range RR as shape parameters. The gradients θ1, θ2 represent respective gradients of approximate straight lines EL1, EL2 of the waveform curve in the range RR.

The template information includes waveform data of disease images. In step S25, the waveform data of the post-correction image AP and the waveform data in the template information are compared with each other with respect to the range RR and the gradients θ1, θ2 in the waveform data designated by the user, the degree of coincidence with respect to the gradients θ1, θ2 of the waveform is calculated, and disease candidates are extracted based on the distribution characteristic value and, in addition, the degree of coincidence or similarity of the shape of the waveform of the luminance value distribution.

In FIG. 34, for example, the user designates curves DC1, DC2 having a predetermined interval DR therebetween as a range where the degree of coincidence of the shape of the waveform is to be determined.

In step S25, the waveform data of the post-correction image AP and the waveform data in the template information are compared with each other with respect to the range defined by the curves DC1, DC2 in the waveform data designated by the user, the degree of coincidence of the waveform is calculated, and disease candidates are extracted based on the distribution characteristic value and, in addition, the degree of coincidence or similarity of the shape of the waveform of the luminance value distribution. The degree of coincidence of the waveform is calculated according to pattern matching, for example.

In FIG. 33, the user can change the setting of the range RR. In FIG. 34, the user can change the interval DR and the shapes of the curves DC1, DC2.

Consequently, the user can diagnose a disease by obtaining information of disease candidates with the waveform shape added.

Modification 3

When the user can anticipate a disease in advance, the image analyzing apparatus may automatically select an observation mode depending on the anticipated disease to acquire an endoscopic image, calculate a distribution characteristic value from the acquired endoscopic image, and calculate the degree of coincidence with the distribution characteristic value in the image of the anticipated disease.

FIG. 35 is a part of a flowchart of a process from the acquisition of an endoscopic image to the presentation of disease information according of Modification 3. FIG. 35 includes the processing sequences illustrated in FIGS. 8 and 9 described hereinbefore.

When the user enters an anticipated disease name into the video processor 3 using the input device, not depicted, such as a control panel or the like, the information controller 38 acquires information of the disease name anticipated by the user in step S61.

The recording portion 37 has information of a plurality of disease names and information of observation modes suitable for the diagnosis of each disease, registered in advance.

Based on the entered anticipated disease name, the controller 31 selects an observation mode suitable for the disease in step S62, and operates the endoscopic system 1 in the selected observation mode in step S63. As a result, the endoscopic system operates in the selected observation mode.

Step S63 is followed by the processing of step S11 illustrated in FIG. 8. The processing from step S11 will not be described hereinafter. In step S25, disease candidates are extracted based on the template information corresponding to the entered disease name.

As a result, the accuracy of the extraction of disease candidates is increased.

Modification 4

According to the embodiment described hereinbefore, disease candidates are extracted using the endoscopic image in the set observation mode, i.e., in the NBI mode in the example described hereinbefore. However, disease candidates may be output from a plurality of disease candidates obtained in a plurality of observation modes.

For example, the user may be presented with disease candidates in a descending order of degrees of coincidence from among one or two or more diseases estimated from an endoscopic image of a certain region in the normal light observation mode and one or two or more diseases estimated from an endoscopic image of the certain region in the NBI mode, or with a disease candidate with the highest degree of coincidence obtained in the observation modes.

Modification 5

According to the embodiment described hereinbefore, the pre-correction image acquirer 51 acquires an image obtained by the endoscope 2 as a pre-correction image BP, which is supplied as it is to the structured element designator 52 and the corrective image generator 53. A signal generator 33 according to Modification 5 is arranged to correct luminance irregularities of the pre-correction image BP obtained by the endoscope 2 due to light distribution characteristics obtained by a simulation or the actual device, and to supply the corrected pre-correction image BP to the structured element designator 52 and the corrective image generator 53.

Only an arrangement concerned with Modification 5 will be described hereinafter.

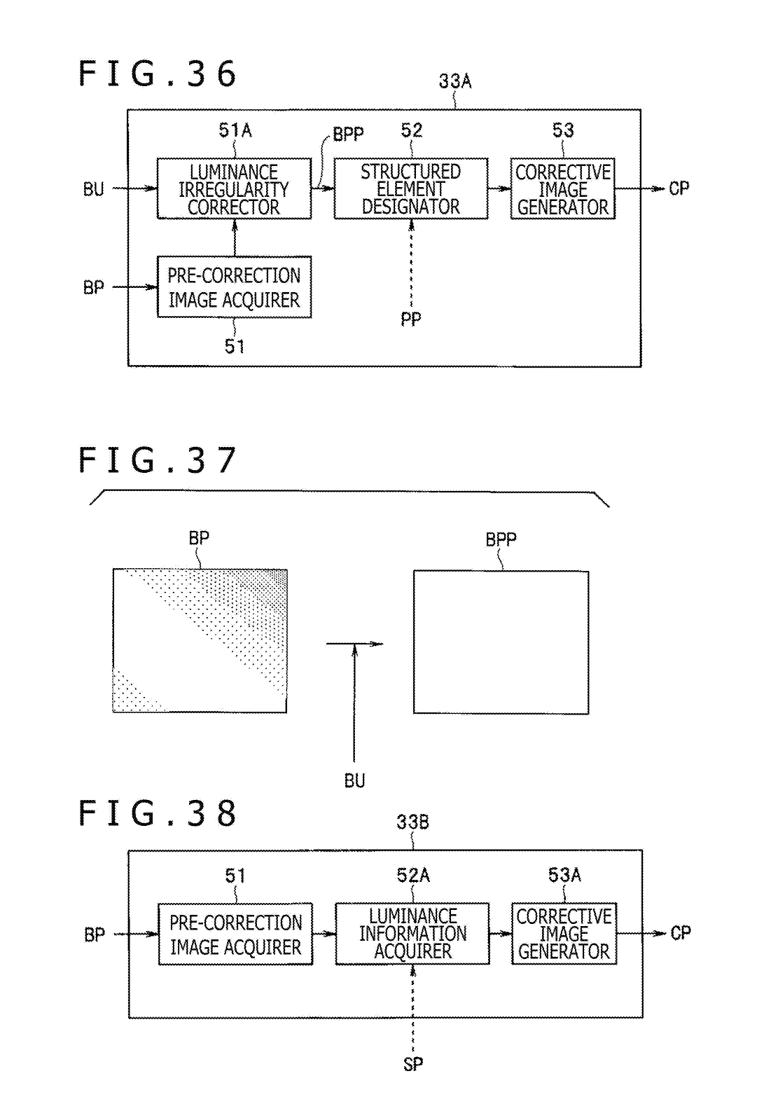

FIG. 36 is a block diagram of a signal generator 33A according to Modification 5. A pre-correction image BP acquired by the pre-correction image acquirer 51 is input to a luminance irregularity corrector 51A that corrects luminance irregularities due to light distribution characteristics. The luminance irregularity corrector 51A, which is supplied with luminance irregularity data BU and the pre-correction image BP from the pre-correction image acquirer 51, corrects the pre-correction image BP to restrain the luminance irregularities due to light distribution characteristics based on the luminance irregularity data BU, thereby generating a pre-correction image BPP free of luminance irregularities.

The luminance irregularity corrector 51A is a processor for correcting the endoscopic image IMG input to the image input portion 32 to eliminate luminance irregularities thereof due to light distribution characteristics obtained by a simulation or the actual device.

FIG. 37 is a diagram illustrating a process for generating a pre-correction image BPP free of luminance irregularities. As illustrated in FIG. 37, the pre-correction image BP originally has luminance irregularities due to light distribution characteristics. In FIG. 37, the pre-correction image BP has such luminance irregularities that its upper right portion is darker. The luminance irregularity corrector 51A corrects the pre-correction image BP to eliminate the luminance irregularities using the luminance irregularity data BU, thereby generating a pre-correction image BPP free of luminance irregularities. In other words, the signal generator 33A generates a corrective image CP that represents brightness distribution correcting data, using the endoscopic image IMG whose luminance irregularities have been corrected by the luminance irregularity corrector 51A.

The luminance irregularity data BU may be data obtained by performing a light distribution simulation on light that passes through an illuminating optical system in the distal-end portion of the insertion portion of the endoscope 2 or data obtained by actually measuring a light distribution of illumination light of the endoscope 2.

Since luminance irregularities vary depending on the distance between the subject and the distal-end portion of the insertion portion, luminance irregularity data BU are established with respect to each value of the distance according to simulating operations or actual measurements.

According to the simulating operations, luminance irregularity data BU can be generated by a simulation for each value of the distance.

According to actual measurements, luminance irregularity data BU can be generated from an endoscopic image captured for each value of the distance with a white balance cap, for example, being disposed on or in the vicinity of the distal-end portion of the insertion portion of the endoscope 2.

The user, while seeing an endoscopic image, selects or designates luminance irregularity data BU to be used depending on the size of the subject, e.g., a small intestinal villus, i.e., depending on the distance from the distal-end portion of the insertion portion to the subject, which the user has estimated by seeing the image of the subject.

As a result, the luminance irregularity corrector 51A removes the brightness distribution originally owned by the pre-correction image BP, with the selected luminance irregularity data BU, and outputs the pre-correction image BPP free of luminance irregularities.

According to Modification 5, inasmuch as the pre-correction image BPP free of luminance irregularities is supplied to the structured element designator 52 and the corrective image generator 53, the luminance values of color components of the body can be detected more accurately.

Modification 6

According to the embodiment described hereinbefore, the corrective image CP is generated from the pre-correction image BP by performing an image processing process such as an opening process using a structured element. According to the present embodiment, the corrective image CP is generated based on a plurality of pixel values at sampling points on the pre-correction image BP.

An endoscopic system according to Modification 6 is of substantially the same configuration as the endoscopic system according to the embodiment. Those components which are identical are denoted by identical numeral references, and only different components will be described hereinafter.

The endoscopic system according to Modification 6 is different from the endoscopic system 1 according to the embodiment only as to a signal generator.

FIG. 38 is a block diagram of a signal generator 33B according to Modification 6. The signal generator 33B includes the pre-correction image acquirer 51, a luminance information acquirer 52A, and a corrective image generator 53A. The pre-correction image BP acquired by the pre-correction image acquirer 51 is input to the luminance information acquirer 52A, which acquires luminance information at a plurality of designated points SP.

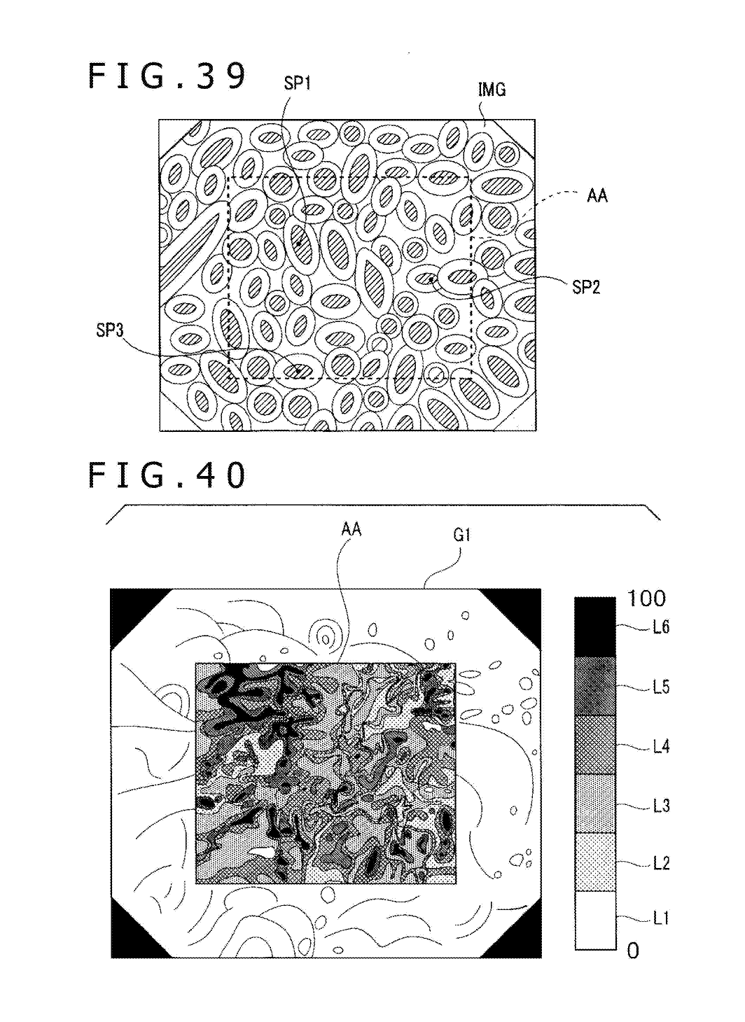

FIG. 39 is a diagram illustrating three points designated in the pre-correction image BP. FIG. 39 illustrates three points SP1, SP2, SP3 designated as a plurality of points SP where luminance information is to be acquired. The points SP may be designated on the screen by the user or may be established in advance in the analysis target area AA.

The corrective image generator 53A of the signal generator 33B calculates a plane determined by the luminance values at the designated three points SP1, SP2, SP3, and generates a corrective plane depending on the direction of inclination and size of the calculated plane, i.e., a corrective image CP. The corrective image CP that is generated by the corrective image generator 53A is an image defining a luminance value distribution with the gradient of the plane determined by the luminance values at the designated three points SP1, SP2, and SP3.

The signal generator 33B generates a corrective image CP from brightness distribution correcting data based on the brightness differences between the points in the endoscopic image IMG

The corrective image generator 53A generates, using the luminance values at the three points SP1, SP2, SP3 in the endoscopic image IMG a corrective image CP for correcting the brightness distribution of the endoscopic image IMG whose brightness has an overall gradient to restrain optical effects on the color components that make up the endoscopic image IMG.

The image processor 34 generates a post-correction image AP from the pre-correction image BP of the endoscopic image IMG using the corrective image CP generated by the corrective image generator 53A.

According to Modification 6, therefore, it is possible to generate a post-correction image AP free of effects of an image brightness distribution due to the light distribution characteristics of illumination light.

Modification 7

According to the embodiment and each of the modifications described hereinbefore, the captured endoscopic image is displayed, together with the analysis target area AA, in the live image display portion G1 illustrated in FIG. 22. The image in the analysis target area AA may be changed to a color map display image according to an instruction from the user.

FIG. 40 is a diagram illustrating an example wherein an image in the analysis target area AA of the live image display portion G1 is displayed in a color map according to Modification 7.

A plurality of pixels in the analysis target area AA are displayed in colors depending on the luminance values of the pixels. In FIG. 40, the pixels are displayed in colors designated depending on the luminance values. For example, if it is assumed that the luminance values are in a range of 0 to 100, and the range is divided into six ranges whose six colors are red, orange, yellow, green, blue, and ultramarine blue, then the pixels in the range L6 whose luminance value is highest are displayed in red (indicated as black in FIG. 40), and pixels in the range L5 whose luminance value is second highest are displayed in orange (indicated as dark gray in FIG. 40). Similarly, the pixels having the luminance values L4, L3, L2, and L1 are displayed respectively in yellow, green, blue, and ultramarine blue.

Using the color map display image, the user is able to recognize an area whose luminance value is high or low visually with ease.

Modification 8

According to the embodiment and each of the modifications described hereinbefore, disease candidates are displayed with respect to an endoscopic image obtained during an endoscopic observation. Images obtained during an endoscopic observation may be recorded in a memory device, and disease candidates may be displayed with respect to an endoscopic image IMG selected from the recorded images. Stated otherwise, color components of an image of the body may be detected on-line in real time during an examination of the body or may be detected off-line after an examination of the body.

According to the embodiment and each of the modifications described hereinbefore, therefore, there are provided an image analyzing apparatus, an image analyzing system, and a method of operating an image analyzing apparatus, which are capable of accurately retrieving an image similar to a medical image including information of obtained colors while restraining the effects of luminance irregularities in endoscopic images.

The “portions” and similar parts in the present description represent conceptual entities corresponding to the functions referred to in the embodiment, and may not necessarily represent a one-to-one correspondence to particular hardware or software routine. In the present description, the embodiment has been described with respect to hypothetical circuit blocks or portions having the functions referred to in the embodiment. The steps of the processing sequences according to the present embodiment may be changed as to the order of execution, may be carried out simultaneously, or may be carried out in a different order in each cycle of execution, unless such alternatives have adverse effects on the steps. Furthermore, all or some of the steps of the processing sequences according to the present embodiment may be implemented by hardware.

Programs for carrying out the operations described hereinbefore are recorded or stored wholly or partly as computer program products in portable mediums such as flexible disks, CD (Compact Disc)-ROMS, or the like or storage mediums such as hard disks or the like. When the programs are read by a computer, the operations are carried out wholly or partly. Alternatively, the programs can be distributed or presented wholly or partly via a communication network. The user can download the programs via the communication network and install the programs into a computer, or can install the programs from the recording medium into a computer, thereby realizing the endoscopic system according to the present disclosure with ease.

In sum, the disclosed technology is directed to an image analyzing apparatus that comprises an image input portion configured to input an endoscopic image of a body which is acquired by an endoscope inserted into the body. An image processor is configured to generate a brightness-corrected image constructed from the endoscopic image that is corrected to the brightness-corrected image wherein the brightness-corrected image includes a brightness distribution that being substantially uniform. A distribution characteristic value calculator is configured to extract at least one of color components defined by a red color component, a green color component, and a blue color component in the brightness-corrected image and is configured to determine a first distribution characteristic value of luminance values of the color component extracted from the brightness-corrected image and numbers of pixels corresponding to the luminance values. A recording portion is configured to record information including a plurality of second distribution characteristic values of luminance values with respect to the color components of a plurality of endoscopic images and numbers of pixels corresponding to the luminance values. A comparison information output portion is configured to compare the plurality of second distribution characteristic values of the luminance values with the first distribution characteristic value of the luminance values and configured to output information regarding a state of the body from the result of comparison being executed.

An image analyzing system comprises an endoscope and an image analyzing apparatus. The image analyzing apparatus includes an image input portion configured to input an endoscopic image of a body which is acquired by an endoscope inserted into the body. An image processor is configured to generate a brightness-corrected image constructed from the endoscopic image being corrected to the brightness-corrected image wherein the brightness-corrected image includes a brightness distribution that being substantially uniform. A distribution characteristic value calculator is configured to extract at least one of a red color component, a green color component, and a blue color component in the brightness-corrected image and configured to determine a first distribution characteristic value based on luminance values of the color component extracted from the brightness-corrected image and numbers of pixels corresponding to the luminance values. A recording portion is configured to record information including a plurality of second distribution characteristic values based on luminance values with respect to the color components of a plurality of endoscopic images and numbers of pixels corresponding to the luminance values. A comparison information output portion configured to compare the plurality of second distribution characteristic values with the first distribution characteristic value and configured to output information regarding a state of the body from the result of comparison.

A method of image analyzing comprises the steps of inputting an endoscopic image of a body which is acquired by an endoscope inserted into the body. Next, generating a brightness-corrected image constructed from the endoscopic image that is corrected to the brightness-corrected image wherein the brightness-corrected image includes a brightness distribution that being substantially uniform. Next, extracting at least one of a red color component, a green color component, and a blue color component in the brightness-corrected image and determining, with a distribution characteristic value calculator, a first distribution characteristic value based on luminance values of the color component extracted from the brightness-corrected image and numbers of pixels corresponding to the luminance values. Next, obtaining a plurality of second distribution characteristic values with respect to the color components of the endoscopic image, the plurality of second distribution characteristic values and numbers of pixels corresponding to the luminance values are recorded in a recording portion. Then, comparing the plurality of second distribution characteristic values with the first distribution characteristic value determined by the distribution characteristic value calculator. Finally, outputting information regarding a state of the body from the result of comparison.

The present disclosure is not limited to the embodiment described hereinbefore, but various changes and modifications may be made therein without departing from the scope of the invention.

What is claimed is:

1. An image analyzing apparatus comprising:
an image input portion configured to input an endoscopic image of a body which is acquired by an endoscope inserted into the body;
an image processor configured to generate a brightness-corrected image constructed from the endoscopic image that being corrected to the brightness-corrected image wherein the brightness-corrected image includes a brightness distribution that being substantially uniform;
a distribution characteristic value calculator being configured to extract at least one of color components defined by a red color component, a green color component, and a blue color component in the brightness-corrected image and being configured to determine a first distribution characteristic value of luminance values of the color component extracted from the brightness-corrected image and numbers of pixels corresponding to the luminance values;
a recording portion configured to record information including a plurality of second distribution characteristic values of luminance values with respect to the color components of a plurality of endoscopic images and numbers of pixels corresponding to the luminance values; and
a comparison information output portion configured to compare the plurality of second distribution characteristic values of the luminance values with the first distribution characteristic value of the luminance values and configured to output information regarding a state of the body from the result of comparison being executed.

2. The image analyzing apparatus of claim 1 further comprising:
a corrective image generator configured to generate a corrective image for correcting the brightness of the endoscopic image, using the endoscopic image input from the image input portion and
wherein the image processor generates the brightness-corrected image by identifying difference between the corrective image and the endoscopic image.

3. The image analyzing apparatus of claim 2,
wherein the corrective image generator generates the corrective image by
detecting a plurality of edges defining inner closed curves and outer closed curves in the endoscopic image,
establishing, as a structured element, a range whose size does not exceed an average value of the sizes of inscribed circles in the inner closed curves in a plurality of areas surrounded by the edges in the endoscopic image,
establishing a plurality of pixels of interest from the endoscopic image,
acquiring information regarding luminance of a plurality of pixels in the range as the structured element, with the pixels of interest at respective centers thereof,
carrying out a contraction processing operation and an expansion processing operation on the acquired luminance of the pixels
replacing luminance values of the pixels of interest with luminance values obtained as a result of the contraction processing operation and the expansion processing operation, and
performing the replacing process on the pixels making up the endoscopic image in its entirety.

4. The image analyzing apparatus of claim 3, wherein the corrective image generator establishes the pixels making up the endoscopic image as the pixels of interest and acquires information regarding luminance of the pixels in the range as the structured element, with the pixels making up the endoscopic image at respective centers thereof

5. The image analyzing apparatus of claim 4, wherein the corrective image generator carries out the contraction processing operation and the expansion processing operation on the pixels that exist in the range as the structured element when the pixels of interest are disposed in a peripheral area of the endoscopic image, or carries out the contraction processing operation and the expansion processing operation by performing the replacing process to replace non-existent pixels with an average luminance value in the range as the structured element.

6. The image analyzing apparatus of claim 3, wherein the corrective image generator establishes, as the structured element, a first circle having a diameter whose size does not exceed the average value of the diameters of the inscribed circles in the inner closed curves in the areas surrounded by the edges, acquires information regarding luminance of the pixels in the range of the first circle with the pixels of interest at the respective centers thereof, and carries out the contraction processing operation and the expansion processing operation on the acquired luminance of the pixels.

7. The image analyzing apparatus of claim 1, wherein each of the second distribution characteristic values recorded in the recording portion includes a distribution characteristic value of an extracted color component, the extracted color component being at least one of the red color component, the green color component, and the blue color component in a brightness-corrected image, the brightness-corrected image being an image of a disease that is corrected such that an image brightness distribution of the image of the disease is substantially uniform.

8. The image analyzing apparatus of claim 1, wherein the comparison information output portion compares:
the distribution characteristic values with respect to the red color component, the green color component, and the blue color component in the information of the second distribution characteristic values recorded in the recording portion; and
the first distribution characteristic value with respect to the red color component, the green color component, and the blue color component in the brightness-corrected image with each other.

9. The image analyzing apparatus of claim 1, wherein the recording portion includes template information of luminance value distributions with respect to the red color component, the green color component, and the blue color component in an image of a disease.

10. The image analyzing apparatus of claim 9,
wherein the recording portion includes information of various diseases, and
the template information further includes information of the image of the disease.

11. The image analyzing apparatus of claim 2 further comprising:
an area extractor configured to define an analysis target area in the endoscopic image input from the image input portion,
wherein the brightness-corrected image includes a corrected image of the analysis target area defined by the area extractor.

12. The image analyzing apparatus of claim 1,
wherein the endoscope has an illuminating portion configured to illuminate the body with white light or narrow-band light having a band narrower than the white light, and
when the body is illuminated with the narrow band light, the distribution characteristic value calculator extracts at least the green color component and the blue color component in the brightness-corrected image and determines a distribution characteristic value of each color component.

13. The image analyzing apparatus of claim 1, wherein the comparison information output portion outputs information of a degree of coincidence between the second distribution characteristic values in the recording portion and the first distribution characteristic value determined by the distribution characteristic value calculator.

14. The image analyzing apparatus of claim 13,
wherein the comparison information output portion outputs to a display device, the information of the degree of coincidence together with a graph indicating a distribution regarding the luminance with respect to the color components determined by the distribution characteristic value calculator, and
the comparison information output portion outputs an image of a disease with respect to the information of the degree of coincidence to the display device for the display to display the image of the disease.

15. The image analyzing apparatus of claim 1, wherein the distribution characteristic value determined by the first distribution characteristic value calculator and the second distribution characteristic values recorded in the recording portion are indicated by respective histograms each having an axis representing luminance values in a target area of the brightness-corrected image and an axis representing numbers of pixels corresponding to the luminance values in the target area.

16. An image analyzing system comprising:
an endoscope; and
an image analyzing apparatus having:
an image input portion configured to input an endoscopic image of a body which is acquired by an endoscope inserted into the body;
an image processor configured to generate a brightness-corrected image constructed from the endoscopic image being corrected to the brightness-corrected image wherein the brightness-corrected image includes a brightness distribution that being substantially uniform;
a distribution characteristic value calculator configured to extract at least one of a red color component, a green color component, and a blue color component in the brightness-corrected image and configured to determine a first distribution characteristic value based on luminance values of the color component extracted from the brightness-corrected image and numbers of pixels corresponding to the luminance values;
a recording portion configured to record information including a plurality of second distribution characteristic values based on luminance values with respect to the color components of a plurality of endoscopic images and numbers of pixels corresponding to the luminance values; and
a comparison information output portion configured to compare the plurality of second distribution characteristic values with the first distribution characteristic value and configured to output information regarding a state of the body from the result of comparison.

17. A method of image analyzing comprising:
inputting an endoscopic image of a body which is acquired by an endoscope inserted into the body;
generating a brightness-corrected image constructed from the endoscopic image that being corrected to the brightness-corrected image wherein the brightness-corrected image includes a brightness distribution that being substantially uniform;
extracting at least one of a red color component, a green color component, and a blue color component in the brightness-corrected image and
determining, with a distribution characteristic value calculator, a first distribution characteristic value based on luminance values of the color component extracted from the brightness-corrected image and numbers of pixels corresponding to the luminance values;
obtaining a plurality of second distribution characteristic values with respect to the color components of the endoscopic image, the plurality of second distribution characteristic values and numbers of pixels corresponding to the luminance values are recorded in a recording portion;
comparing the plurality of second distribution characteristic values with the first distribution characteristic value determined by the distribution characteristic value calculator; and
outputting information regarding a state of the body from the result of comparison.
